(19) United States
(12) Patent Application Publication
(10) Pub. No.: US 2025/0111408 A1
(43) Pub. Date: Apr. 3, 2025

(54) Method, System, and Computer Program Product for Improving Matching Algorithms

(71) Applicant: Visa International Service Association, San Francisco, CA (US)

(72) Inventors: Robert B. Hedges, Jr., Orford, NH (US); Nirmal Kumar Baid, San Jose, CA (US); Nicholas Bryan Kurlas, New York, NY (US); Kimberly E. Bella, Walnut Creek, CA (US)

(21) Appl. No.: 18/905,709

(22) Filed: Oct. 3, 2024

Related U.S. Application Data
(60) Provisional application No. 63/542,174, filed on Oct. 3, 2023.

(51) Int. Cl. G06Q 30/0251; G06N 20/00

(52) U.S. Cl. CPC G06Q 30/0269; G06N 20/00; G06Q 30/0267

(57) ABSTRACT

Methods, systems, and computer program products are provided for improving matching algorithms. A method may include: receiving user privacy settings and interest preference data; storing the data in a database; inputting the interest preferences data into a machine learning algorithm to generate at least one match between the user and a merchant, wherein the merchant comprises a subset of a plurality of merchants; generating a data sharing message by: compiling first data associated with the user; filtering the first data based on interest preference data and/or privacy settings data to generate shareable data; and for each merchant associated with a subset of the data associated a merchant, generating a corresponding data sharing message containing a subset of interest preference data; and distributing the corresponding data sharing messages.

### CROSS REFERENCE TO RELATED APPLICATION

This application claims priority to U.S. Provisional Patent Application No. 63/542,174 filed on Oct. 3, 2023, the disclosure of which is hereby incorporated by reference in its entirety.

### BACKGROUND

### 1. Technical Field

This disclosure relates generally to matching algorithms and, in some non-limiting embodiments or aspects, to methods, systems, and computer program products for improving matching algorithms.

### 2. Technical Considerations

Machine learning models can be used to suggest matches between users and potentially relevant merchants. However, existing matching algorithms track user web behavior and attempt to infer user interests, leading to a mismatch between suggested users and merchants. These models do not consider user preference data submitted directly thereto by the user, which also reduces their ability to efficiently detect changing user interests over time and provide relevant matches for the user's current interests. Moreover, existing systems lack a user ability to control data representing their current interests including, but not limited to, interest preference data and its dissemination to less relevant merchants.

### SUMMARY

Accordingly, provided are improved methods, systems, and computer program products for improving matching algorithms.

According to non-limiting embodiments or aspects, provided is a method for improving matching algorithms. In some non-limiting embodiments or aspects, the method may include receiving user profile data including privacy settings data and interest preference data of a user. In some non-limiting embodiments or aspects, the method may include storing the user profile data in a database. In some non-limiting embodiments or aspects, the method may include inputting the interest preference data into a machine learning algorithm to generate at least one match between the user and at least one merchant of a plurality of merchants, where the at least one merchant includes a subset of the plurality of merchants. In some non-limiting embodiments or aspects, the method may include, based on the at least one match, generating at least one data sharing message by: compiling first data associated with the user, the first data including the interest preference data and data associated with the at least one merchant; filtering the first data based on at least one of the interest preference data and the privacy settings data to generate shareable data including a subset of at least one of the interest preference data and the data associated with the at least one merchant; and for each merchant associated with the subset of the data associated with the at least one merchant, generating a corresponding data sharing message containing the subset of interest preference data. In some non-limiting embodiments or aspects, the method may include distributing the corresponding data sharing message to each merchant system associated with each merchant associated with the subset of the data associated with the at least one merchant.

In some non-limiting embodiments or aspects, the method may further include preventing distribution of the interest preference data to merchants of the plurality of merchants not associated with the subset of the data associated with the at least one merchant.

In some non-limiting embodiments or aspects, the method may further include causing a white label configured user interface to display on a device of the user through a merchant system during a transaction between the user and the merchant system; and receiving the user profile data in response to the user engaging the white label configured user interface.

In some non-limiting embodiments or aspects, the method may further include receiving merchant profile data for each merchant of the plurality of merchants, the merchant profile data including merchant preference data; inputting the merchant profile data into the machine learning algorithm; and generating the at least one match between the user and at least one merchant using the machine learning algorithm based on the interest preference data and the merchant preference data.

In some non-limiting embodiments or aspects, the method may further include, in response to a device of the user receiving a first offer from a merchant to which a data sharing message was distributed, causing a feedback user interface to display on the device of the user, the feedback user interface including at least one selectable element; receiving feedback data from the user device based on a user input to the feedback user interface by the user interacting with the at least one selectable element; and inputting the feedback data to the machine learning algorithm to further train the machine learning algorithm.

In some non-limiting embodiments or aspects, the method may further include compiling a plurality of offers for the user from a plurality of merchants to which a data sharing message was distributed; generating an offers message including the compiled plurality of offers; and transmitting the offers message to a device of the user.

In some non-limiting embodiments or aspects, the method may further include receiving user profile data from a source that has proactively been added as an accessible source; receiving, from a device of the user, updated user profile data including updated interest preference data, updated privacy settings data, and/or updated historical user transaction data; and storing and/or replacing, in the database, the interest preference data and privacy settings data with the updated interest preference data, the updated privacy settings data, and/or the updated historical user transaction data.

In some non-limiting embodiments or aspects, the interest preference data may include at least one of a preferred or a non-preferred merchant, a preferred offer timing, a user spend estimate, a user financial profile, one or more activities of the user, and one or more objectives of the user.

In some non-limiting embodiments or aspects, the privacy settings data may include a restriction on sharing at least a portion of the interest preference data and/or historical user transaction data of the user.

In some non-limiting embodiments or aspects, the interest preference data may include a list of user-approved merchants. In some non-limiting embodiments or aspects, the method may further include, in response to a device of the user receiving a message, automatically determining that the message is not from a merchant on the list of user-approved merchants; and causing a display of the device of the user to display a user-selectable warning element.

In some non-limiting embodiments or aspects, the interest preference data may include loan parameters. In some non-limiting embodiments or aspects, the method may further include receiving merchant profile data for each merchant of the plurality of merchants, the merchant profile data including loan offer data; inputting the loan offer data into the machine learning algorithm; and generating the at least one match between the user and the at least one merchant using the machine learning algorithm based on the loan parameters and the loan offer data.

In some non-limiting embodiments or aspects, the method may further include generating a suggested action for the user based on the interest preference data; generating a suggestion message containing the suggested action; and transmitting the suggestion message to a device of the user to cause the suggestion action to be displayed on a user interface on the device.

In some non-limiting embodiments or aspects, receiving the user profile data may include receiving the user profile data independent of transmitting a user profile request or an advertisement message to a user associated with the user profile data.

In some non-limiting embodiments or aspects, receiving the user profile data may include receiving the user profile data via a chatbot interface.

In some non-limiting embodiments or aspects, the method may further include receiving merchant profile data for each merchant of the plurality of merchants, the merchant profile data including merchant offer data; and storing the merchant profile data in the database. In some non-limiting embodiments or aspects, inputting the interest preference data into the machine learning algorithm to generate at least one match between the user and the at least one merchant of a plurality of merchants may include inputting the interest preference data into the machine learning algorithm and merchant profile data for a merchant of the plurality of merchants to generate at least one match between the user and the at least one merchant of a plurality of merchants.

In some non-limiting embodiments or aspects, distributing the corresponding data sharing message to each merchant system associated with each merchant associated with the subset of the data associated with the at least one merchant may include distributing the corresponding data sharing message to each merchant system associated with each merchant associated with the subset of the data associated with the at least one merchant based on determining that the user has provided an indication of an access grant.

According to non-limiting embodiments or aspects, provided is a system for improving matching algorithms. The system may include at least one processor. In some non-limiting embodiments or aspects, the at least one processor may be configured to receive user profile data including privacy settings data and interest preference data of a user. In some non-limiting embodiments or aspects, the at least one processor may be configured to store the user profile data in a database. In some non-limiting embodiments or aspects, the at least one processor may be configured to input the interest preference data into a machine learning algorithm to generate at least one match between the user and at least one merchant of a plurality of merchants, where the at least one merchant includes a subset of the plurality of merchants. In some non-limiting embodiments or aspects, the at least one processor may be configured to, based on the at least one match, generate at least one data sharing message. In some non-limiting embodiments or aspects, when generating the at least one data sharing message, the at least one processor may be configured to: compile first data associated with the user, the first data including the interest preference data and data associated with the at least one merchant; filter the first data based on at least one of the interest preference data and the privacy settings data to generate shareable data including a subset of at least one of the interest preference data and the data associated with the at least one merchant; and for each merchant associated with the subset of the data associated with the at least one merchant, generate a corresponding data sharing message containing the subset of interest preference data. In some non-limiting embodiments or aspects, the at least one processor may be configured to distribute the corresponding data sharing message to each merchant system associated with each merchant associated with the subset of the data associated with the at least one merchant.

In some non-limiting embodiments or aspects, the at least one processor may be further to prevent distribution of the interest preference data to merchants of the plurality of merchants not associated with the subset of the data associated with the at least one merchant.

In some non-limiting embodiments or aspects, the at least one processor may be further configured to cause a white label configured user interface to display on a device of the user through a merchant system during a transaction between the user and the merchant system; and receive the user profile data in response to the user engaging the white label configured user interface.

In some non-limiting embodiments or aspects, the at least one processor may be configured to receive merchant profile data for each merchant of the plurality of merchants, the merchant profile data including merchant preference data; input the merchant profile data into the machine learning algorithm; and generate the at least one match between the user and at least one merchant using the machine learning algorithm based on the interest preference data and the merchant preference data.

In some non-limiting embodiments or aspects, the at least one processor may be further configured to, in response to a device of the user receiving a first offer from a merchant to which a data sharing message was distributed, cause a feedback user interface to display on the device of the user, the feedback user interface including at least one selectable element; receive feedback data from the user device based on a user input to the feedback user interface by the user interacting with the at least one selectable element; and input the feedback data to the machine learning algorithm to further train the machine learning algorithm.

In some non-limiting embodiments or aspects, the at least one processor may be further configured to compile a plurality of offers for the user from a plurality of merchants to which a data sharing message was distributed; generate an offers message including the compiled plurality of offers; and transmit the offers message to a device of the user.

In some non-limiting embodiments or aspects, the at least one processor may be further configured to receive user profile data from a source that has proactively been added as an accessible source; receive, from a device of the user, updated user profile data including updated interest preference data, updated privacy settings data, and/or updated historical user transaction data; and store and/or replace, in the database, the interest preference data and privacy settings data with the updated interest preference data, the updated privacy settings data, and/or the updated historical user transaction data.

In some non-limiting embodiments or aspects, the interest preference data may include at least one of a preferred or a non-preferred merchant, a preferred offer timing, a user spend estimate, a user financial profile, one or more activities of the user, and one or more objectives of the user.

In some non-limiting embodiments or aspects, the privacy settings data may include a restriction on sharing at least a portion of the interest preference data and/or historical user transaction data of the user.

In some non-limiting embodiments or aspects, the interest preference data may include a list of user-approved merchants. In some non-limiting embodiments or aspects, the at least one processor may be further configured to, in response to a device of the user receiving a message, automatically determine that the message is not from a merchant on the list of user-approved merchants; and cause a display of the device of the user to display a user-selectable warning element.

In some non-limiting embodiments or aspects, the interest preference data may include loan parameters. In some non-limiting embodiments or aspects, the at least one processor may be further configured to receive merchant profile data for each merchant of the plurality of merchants, the merchant profile data including loan offer data; input the loan offer data into the machine learning algorithm; and generate the at least one match between the user and the at least one merchant using the machine learning algorithm based on the loan parameters and the loan offer data.

In some non-limiting embodiments or aspects, the at least one processor may be further configured to generate a suggested action for the user based on the interest preference data; generate a suggestion message containing the suggested action; and transmit the suggestion message to a device of the user to cause the suggestion action to be displayed on a user interface on the device.

In some non-limiting embodiments or aspects, when receiving the user profile data, the at least one processor may be further configured to receive the user profile data independent of transmitting a user profile request or an advertisement message to a user associated with the user profile data.

In some non-limiting embodiments or aspects, when receiving the user profile data, the at least one processor may be configured to receive the user profile data via a chatbot interface.

In some non-limiting embodiments or aspects, the at least one processor may be further configured to receive merchant profile data for each merchant of the plurality of merchants, the merchant profile data including merchant offer data; and store the merchant profile data in the database. In some non-limiting embodiments or aspects, when inputting the interest preference data into the machine learning algorithm to generate at least one match between the user and the at least one merchant of a plurality of merchants, the at least one processor may be configured to: input the interest preference data into the machine learning algorithm and merchant profile data for a merchant of the plurality of merchants to generate at least one match between the user and the at least one merchant of a plurality of merchants.

In some non-limiting embodiments or aspects, when distributing the corresponding data sharing message to each merchant system associated with each merchant associated with the subset of the data associated with the at least one merchant, the at least one processor may be configured to distribute the corresponding data sharing message to each merchant system associated with each merchant associated with the subset of the data associated with the at least one merchant based on determining that the user has provided an indication of an access grant.

According to non-limiting embodiments or aspects, provided is a computer program product for improving matching algorithms. In some non-limiting embodiments or aspects, the computer program product may include at least one non-transitory computer-readable medium including program instructions that, when executed by at least one processor, cause the at least one processor to receive user profile data including privacy settings data and interest preference data of a user. In some non-limiting embodiments or aspects, the instructions may cause the at least one processor to store the user profile data in a database. In some non-limiting embodiments or aspects, the instructions may cause the at least one processor to input the interest preference data into a machine learning algorithm to generate at least one match between the user and at least one merchant of a plurality of merchants, where the at least one merchant includes a subset of the plurality of merchants. In some non-limiting embodiments or aspects, the instructions may cause the at least one processor to, based on the at least one match, generate at least one data sharing message. In some non-limiting embodiments or aspects, when generating the at least one data sharing message, the instructions may cause the at least one processor to: compile first data associated with the user, the first data including the interest preference data and data associated with the at least one merchant; filter the first data based on at least one of the interest preference data and the privacy settings data to generate shareable data including a subset of at least one of the interest preference data and the data associated with the at least one merchant; and for each merchant associated with the subset of the data associated with the at least one merchant, generate a corresponding data sharing message containing the subset of interest preference data. In some non-limiting embodiments or aspects, the instructions may cause the at least one processor to distribute the corresponding data sharing message to each merchant system associated with each merchant associated with the subset of the data associated with the at least one merchant.

In some non-limiting embodiments or aspects, the instructions may further cause the at least one processor to prevent distribution of the interest preference data to merchants of the plurality of merchants not associated with the subset of the data associated with the at least one merchant.

In some non-limiting embodiments or aspects, the instructions may further cause the at least one processor to cause a white label configured user interface to display on a device of the user through a merchant system during a transaction between the user and the merchant system; and receive the user profile data in response to the user engaging the white label configured user interface.

In some non-limiting embodiments or aspects, the instructions may further cause the at least one processor to receive merchant profile data for each merchant of the plurality of merchants, the merchant profile data including merchant preference data; input the merchant profile data into the machine learning algorithm; and generate the at least one match between the user and at least one merchant using the machine learning algorithm based on the interest preference data and the merchant preference data.

In some non-limiting embodiments or aspects, the instructions may further cause the at least one processor to, in response to a device of the user receiving a first offer from a merchant to which a data sharing message was distributed, cause a feedback user interface to display on the device of the user, the feedback user interface including at least one selectable element; receive feedback data from the user device based on a user input to the feedback user interface by the user interacting with the at least one selectable element; and input the feedback data to the machine learning algorithm to further train the machine learning algorithm.

In some non-limiting embodiments or aspects, the instructions may further cause the at least one processor to compile a plurality of offers for the user from a plurality of merchants to which a data sharing message was distributed; generate an offers message including the compiled plurality of offers; and transmit the offers message to a device of the user.

In some non-limiting embodiments or aspects, the instructions may further cause the at least one processor to receive user profile data from a source that has proactively been added as an accessible source; receive, from a device of the user, updated user profile data including updated interest preference data, updated privacy settings data, and/or updated historical user transaction data; and store and/or replace, in the database, the interest preference data and privacy settings data with the updated interest preference data, the updated privacy settings data, and/or the updated historical user transaction data.

In some non-limiting embodiments or aspects, the interest preference data may include at least one of a preferred or a non-preferred merchant, a preferred offer timing, a user spend estimate, a user financial profile, one or more activities of the user, and one or more objectives of the user.

In some non-limiting embodiments or aspects, the privacy settings data may include a restriction on sharing at least a portion of the interest preference data and/or historical user transaction data of the user.

In some non-limiting embodiments or aspects, the interest preference data may include a list of user-approved merchants. In some non-limiting embodiments or aspects, the instructions may further cause the at least one processor to, in response to a device of the user receiving a message, automatically determine that the message is not from a merchant on the list of user-approved merchants; and cause a display of the device of the user to display a user-selectable warning element.

In some non-limiting embodiments or aspects, the interest preference data may include loan parameters. In some non-limiting embodiments or aspects, the instructions may further cause the at least one processor to receive merchant profile data for each merchant of the plurality of merchants, the merchant profile data including loan offer data; input the loan offer data into the machine learning algorithm; and generate the at least one match between the user and the at least one merchant using the machine learning algorithm based on the loan parameters and the loan offer data.

In some non-limiting embodiments or aspects, the instructions may further cause the at least one processor to generate a suggested action for the user based on the interest preference data; generate a suggestion message containing the suggested action; and transmit the suggestion message to a device of the user to cause the suggestion action to be displayed on a user interface on the device.

In some non-limiting embodiments or aspects, when receiving the user profile data, the instructions may cause the at least one processor to receive the user profile data independent of transmitting a user profile request or an advertisement message to a user associated with the user profile data.

In some non-limiting embodiments or aspects, when receiving the user profile data, the instructions may cause the at least one processor to receive the user profile data via a chatbot interface.

In some non-limiting embodiments or aspects, the instructions may further cause the at least one processor to receive merchant profile data for each merchant of the plurality of merchants, the merchant profile data including merchant offer data; and store the merchant profile data in the database. In some non-limiting embodiments or aspects, when inputting the interest preference data into the machine learning algorithm to generate at least one match between the user and the at least one merchant of a plurality of merchants, the instructions may cause the at least one processor to input the interest preference data into the machine learning algorithm and merchant profile data for a merchant of the plurality of merchants to generate at least one match between the user and the at least one merchant of a plurality of merchants.

In some non-limiting embodiments or aspects, when distributing the corresponding data sharing message to each merchant system associated with each merchant associated with the subset of the data associated with the at least one merchant, the instructions may cause the at least one processor to distribute the corresponding data sharing message to each merchant system associated with each merchant associated with the subset of the data associated with the at least one merchant based on determining that the user has provided an indication of an access grant.

Further non-limiting embodiments or aspects will be set forth in the following numbered clauses:

Clause 1: A computer-implemented method, comprising: receiving, with at least one processor, user profile data comprising privacy settings data and interest preference data of a user; storing, with at least one processor, the user profile data in a database; inputting, with at least one processor, the interest preference data into a machine learning algorithm to generate at least one match between the user and at least one merchant of a plurality of merchants, wherein the at least one merchant comprises a subset of the plurality of merchants; based on the at least one match, generating, with at least one processor, at least one data sharing message by: compiling first data associated with the user, the first data comprising the interest preference data and data associated with the at least one merchant; filtering the first data based on at least one of the interest preference data and the privacy settings data to generate shareable data comprising a subset of at least one of the interest preference data and the data associated with the at least one merchant; and for each merchant associated with the subset of the data associated with the at least one merchant, generating a corresponding data sharing message containing the subset of interest preference data; and distributing, with at least one processor, the corresponding data sharing message to each merchant system associated with each merchant associated with the subset of the data associated with the at least one merchant.

Clause 2: The computer-implemented method of clause 1, further comprising preventing distribution of the interest preference data to merchants of the plurality of merchants not associated with the subset of the data associated with the at least one merchant.

Clause 3: The computer-implemented method of clause 1 or 2, further comprising: causing, with at least one processor, a white label configured user interface to display on a device of the user through a merchant system during a transaction between the user and the merchant system; and receiving, with the at least one processor, the user profile data in response to the user engaging the white label configured user interface.

Clause 4: The computer-implemented method of any of clauses 1-3, further comprising: receiving, with at least one processor, merchant profile data for each merchant of the plurality of merchants, the merchant profile data comprising merchant preference data; inputting, with at least one processor, the merchant profile data into the machine learning algorithm; and generating, with at least one processor, the at least one match between the user and at least one merchant using the machine learning algorithm based on the interest preference data and the merchant preference data.

Clause 5: The computer-implemented method of any of clauses 1-4, further comprising: in response to a device of the user receiving a first offer from a merchant to which a data sharing message was distributed, causing, with at least one processor, a feedback user interface to display on the device of the user, the feedback user interface comprising at least one selectable element; receiving, with at least one processor, feedback data from the user device based on a user input to the feedback user interface by the user interacting with the at least one selectable element; and inputting, with at least one processor, the feedback data to the machine learning algorithm to further train the machine learning algorithm.

Clause 6: The computer-implemented method of any of clauses 1-5, further comprising: compiling, with at least one processor, a plurality of offers for the user from a plurality of merchants to which a data sharing message was distributed; generating, with at least one processor, an offers message comprising the compiled plurality of offers; and transmitting, with at least one processor, the offers message to a device of the user.

Clause 7: The computer-implemented method of any of clauses 1-6, further comprising: receiving, with at least one processor, user profile data from a source that has proactively been added as an accessible source; receiving, with at least one processor and from a device of the user, updated user profile data comprising updated interest preference data, updated privacy settings data, and/or updated historical user transaction data; and storing and/or replacing, with at least one processor and in the database, the interest preference data and privacy settings data with the updated interest preference data, the updated privacy settings data, and/or the updated historical user transaction data.

Clause 8: The computer-implemented method of any of clauses 1-7, wherein the interest preference data comprises at least one of a preferred or a non-preferred merchant, a preferred offer timing, a user spend estimate, a user financial profile, one or more activities of the user, and one or more objectives of the user.

Clause 9: The computer-implemented method of any of clauses 1-8, wherein the privacy settings data comprises a restriction on sharing at least a portion of the interest preference data and/or historical user transaction data of the user.

Clause 10: The computer-implemented method of any of clauses 1-9, wherein the interest preference data comprises a list of user-approved merchants, wherein the computer-implemented method further comprises: in response to a device of the user receiving a message, automatically determining, with at least one processor, that the message is not from a merchant on the list of user-approved merchants; and causing a display of the device of the user to display a user-selectable warning element.

Clause 11: The computer-implemented method of any of clauses 1-10, wherein the interest preference data comprises loan parameters, wherein the computer-implemented method further comprises: receiving, with at least one processor, merchant profile data for each merchant of the plurality of merchants, the merchant profile data comprising loan offer data; inputting, with at least one processor, the loan offer data into the machine learning algorithm; and generating, with at least one processor, the at least one match between the user and the at least one merchant using the machine learning algorithm based on the loan parameters and the loan offer data.

Clause 12: The computer-implemented method of any of clauses 1-11, further comprising: generating, with at least one processor, a suggested action for the user based on the interest preference data; generating, with at least on processor, a suggestion message containing the suggested action; and transmitting, with at least one processor, the suggestion message to a device of the user to cause the suggestion action to be displayed on a user interface on the device.

Clause 13: The computer-implemented method of any of clauses 1-12, wherein receiving the user profile data comprises: receiving the user profile data independent of transmitting a user profile request or an advertisement message to a user associated with the user profile data.

Clause 14: The computer-implemented method of any of clauses 1-13, wherein receiving the user profile data comprises: receiving the user profile data via a chatbot interface.

Clause 15: The computer-implemented method of any of clauses 1-14, further comprising: receiving merchant profile data for each merchant of the plurality of merchants, the merchant profile data comprising merchant offer data; and storing the merchant profile data in the database; wherein inputting the interest preference data into the machine learning algorithm to generate at least one match between the user and the at least one merchant of a plurality of merchants comprises: inputting the interest preference data into the machine learning algorithm and merchant profile data for a merchant of the plurality of merchants to generate at least one match between the user and the at least one merchant of a plurality of merchants.

Clause 16: The computer-implemented method of any of clauses 1-15, wherein distributing the corresponding data sharing message to each merchant system associated with each merchant associated with the subset of the data associated with the at least one merchant comprises: distributing the corresponding data sharing message to each merchant system associated with each merchant associated with the subset of the data associated with the at least one merchant based on determining that the user has provided an indication of an access grant.

Clause 17: A system, comprising: at least one processor configured to: receive user profile data comprising privacy settings data and interest preference data of a user; store the user profile data in a database; input the interest preference data into a machine learning algorithm to generate at least one match between the user and at least one merchant of a plurality of merchants, wherein the at least one merchant comprises a subset of the plurality of merchants; based on the at least one match, generate at least one data sharing message, wherein when generating the at least one data sharing message, the at least one processor is configured to: compile first data associated with the user, the first data comprising the interest preference data and data associated with the at least one merchant; filter the first data based on at least one of the interest preference data and the privacy settings data to generate shareable data comprising a subset of at least one of the interest preference data and the data associated with the at least one merchant; and for each merchant associated with the subset of the data associated with the at least one merchant, generate a corresponding data sharing message containing the subset of interest preference data; and distribute the corresponding data sharing message to each merchant system associated with each merchant associated with the subset of the data associated with the at least one merchant.

Clause 18: The system of clause 17, wherein the at least one processor is further configured to: prevent distribution of the interest preference data to merchants of the plurality of merchants not associated with the subset of the data associated with the at least one merchant.

Clause 19: The system of clause 17 or 18, wherein the at least one processor is further configured to: cause a white label configured user interface to display on a device of the user through a merchant system during a transaction between the user and the merchant system; and receive the user profile data in response to the user engaging the white label configured user interface.

Clause 20: The system of any of clauses 17-19, wherein the at least one processor is further configured to: receive merchant profile data for each merchant of the plurality of merchants, the merchant profile data comprising merchant preference data; input the merchant profile data into the machine learning algorithm; and generate the at least one match between the user and at least one merchant using the machine learning algorithm based on the interest preference data and the merchant preference data.

Clause 21: The system of any of clauses 17-20, wherein the at least one processor is further configured to: in response to a device of the user receiving a first offer from a merchant to which a data sharing message was distributed, cause a feedback user interface to display on the device of the user, the feedback user interface comprising at least one selectable element; receive feedback data from the user device based on a user input to the feedback user interface by the user interacting with the at least one selectable element; and input the feedback data to the machine learning algorithm to further train the machine learning algorithm.

Clause 22: The system of any of clauses 17-21, wherein the at least one processor is further configured to: compile a plurality of offers for the user from a plurality of merchants to which a data sharing message was distributed; generate an offers message comprising the compiled plurality of offers; and transmit the offers message to a device of the user.

Clause 23: The system of any of clauses 17-22, wherein the at least one processor is further configured to: receive user profile data from a source that has proactively been added as an accessible source; receive, from a device of the user, updated user profile data comprising updated interest preference data, updated privacy settings data, and/or updated historical user transaction data; and store and/or replace, in the database, the interest preference data and privacy settings data with the updated interest preference data, the updated privacy settings data, and/or the updated historical user transaction data.

Clause 24: The system of any of clauses 17-23, wherein the interest preference data comprises at least one of a preferred or a non-preferred merchant, a preferred offer timing, a user spend estimate, a user financial profile, one or more activities of the user, and one or more objectives of the user.

Clause 25: The system of any of clauses 17-24, wherein the privacy settings data comprises a restriction on sharing at least a portion of the interest preference data and/or historical user transaction data of the user.

Clause 26: The system of any of clauses 17-25, wherein the interest preference data comprises a list of user-approved merchants, wherein the at least one processor is further configured to: in response to a device of the user receiving a message, automatically determine that the message is not from a merchant on the list of user-approved merchants; and cause a display of the device of the user to display a user-selectable warning element.

Clause 27: The system of any of clauses 17-26, wherein the interest preference data comprises loan parameters, wherein the at least one processor is further configured to: receive merchant profile data for each merchant of the plurality of merchants, the merchant profile data comprising loan offer data; input the loan offer data into the machine learning algorithm; and generate the at least one match between the user and the at least one merchant using the machine learning algorithm based on the loan parameters and the loan offer data.

Clause 28: The system of any of clauses 17-27, wherein the at least one processor is further configured to: generate a suggested action for the user based on the interest preference data; generate a suggestion message containing the suggested action; and transmit the suggestion message to a device of the user to cause the suggestion action to be displayed on a user interface on the device.

Clause 29: The system of any of clauses 17-28, wherein, when receiving the user profile data, the at least one processor is configured to: receive the user profile data independent of transmitting a user profile request or an advertisement message to a user associated with the user profile data.

Clause 30: The system of any of clauses 17-29 wherein, when receiving the user profile data, the at least one processor is configured to: receive the user profile data via a chatbot interface.

Clause 31: The system of any of clauses 17-30, wherein the at least one processor is further configured to: receive merchant profile data for each merchant of the plurality of merchants, the merchant profile data comprising merchant offer data; and store the merchant profile data in the database; wherein, when inputting the interest preference data into the machine learning algorithm to generate at least one match between the user and the at least one merchant of a plurality of merchants, the at least one processor is configured to: input the interest preference data into the machine learning algorithm and merchant profile data for a merchant of the plurality of merchants to generate at least one match between the user and the at least one merchant of a plurality of merchants.

Clause 32: The system of any of clauses 17-31, wherein, when distributing the corresponding data sharing message to each merchant system associated with each merchant associated with the subset of the data associated with the at least one merchant, the at least one processor is configured to: distribute the corresponding data sharing message to each merchant system associated with each merchant associated with the subset of the data associated with the at least one merchant based on determining that the user has provided an indication of an access grant.

Clause 33: A computer program product comprising at least one non-transitory computer-readable medium including program instructions that, when executed by at least one processor, cause the at least one processor to: receive user profile data comprising privacy settings data and interest preference data of a user; store the user profile data in a database; input the interest preference data into a machine learning algorithm to generate at least one match between the user and at least one merchant of a plurality of merchants, wherein the at least one merchant comprises a subset of the plurality of merchants; based on the at least one match, generate at least one data sharing message, wherein when generating the at least one data sharing message, the instructions cause the at least one processor to: compile first data associated with the user, the first data comprising the interest preference data and data associated with the at least one merchant; filter the first data based on at least one of the interest preference data and the privacy settings data to generate shareable data comprising a subset of at least one of the interest preference data and the data associated with the at least one merchant; and for each merchant associated with the subset of the data associated with the at least one merchant, generate a corresponding data sharing message containing the subset of interest preference data; and distribute the corresponding data sharing message to each merchant system associated with each merchant associated with the subset of the data associated with the at least one merchant.

Clause 34: The computer program product of clause 33, wherein the instructions further cause the at least one processor to: prevent distribution of the interest preference data to merchants of the plurality of merchants not associated with the subset of the data associated with the at least one merchant.

Clause 35: The computer program product of clause 33 or 34, wherein the instructions further cause the at least one processor to: cause a white label configured user interface to display on a device of the user through a merchant system during a transaction between the user and the merchant system; and receive the user profile data in response to the user engaging the white label configured user interface.

Clause 36: The computer program product of any of clauses 33-35, wherein the instructions further cause the at least one processor to: receive merchant profile data for each merchant of the plurality of merchants, the merchant profile data comprising merchant preference data; input the merchant profile data into the machine learning algorithm; and generate the at least one match between the user and at least one merchant using the machine learning algorithm based on the interest preference data and the merchant preference data.

Clause 37: The computer program product of any of clauses 33-36, wherein the instructions further cause the at least one processor to: in response to a device of the user receiving a first offer from a merchant to which a data sharing message was distributed, cause a feedback user interface to display on the device of the user, the feedback user interface comprising at least one selectable element; receive feedback data from the user device based on a user input to the feedback user interface by the user interacting with the at least one selectable element; and input the feedback data to the machine learning algorithm to further train the machine learning algorithm.

Clause 38: The computer program product of any of clauses 33-37, wherein the instructions further cause the at least one processor to: compile a plurality of offers for the user from a plurality of merchants to which a data sharing message was distributed; generate an offers message comprising the compiled plurality of offers; and transmit the offers message to a device of the user.

Clause 39: The computer program product of any of clauses 33-38, wherein the instructions further cause the at least one processor to: receive user profile data from a source that has proactively been added as an accessible source; receive, from a device of the user, updated user profile data comprising updated interest preference data, updated privacy settings data, and/or updated historical user transaction data; and store and/or replace, in the database, the interest preference data and privacy settings data with the updated interest preference data, the updated privacy settings data, and/or the updated historical user transaction data.

Clause 40: The computer program product of any of clauses 33-39, wherein the interest preference data comprises at least one of a preferred or a non-preferred merchant, a preferred offer timing, a user spend estimate, a user financial profile, one or more activities of the user, and one or more objectives of the user.

Clause 41: The computer program product of any of clauses 33-40, wherein the privacy settings data comprises a restriction on sharing at least a portion of the interest preference data and/or historical user transaction data of the user.

Clause 42: The computer program product of any of clauses 33-41, wherein the interest preference data comprises a list of user-approved merchants, wherein the instructions further cause the at least one processor to: in response to a device of the user receiving a message, automatically determine that the message is not from a merchant on the list of user-approved merchants; and cause a display of the device of the user to display a user-selectable warning element.

Clause 43: The computer program product of any of clauses 33-42, wherein the interest preference data comprises loan parameters, wherein the instructions further cause the at least one processor to: receive merchant profile data for each merchant of the plurality of merchants, the merchant profile data comprising loan offer data; input the loan offer data into the machine learning algorithm; and generate the at least one match between the user and the at least one merchant using the machine learning algorithm based on the loan parameters and the loan offer data.

Clause 44: The computer program product of any of clauses 33-43, wherein the instructions further cause the at least one processor to: generate a suggested action for the user based on the interest preference data; generate a suggestion message containing the suggested action; and transmit the suggestion message to a device of the user to cause the suggestion action to be displayed on a user interface on the device.

Clause 45: The computer program product of any of clauses 33-44, wherein, when receiving the user profile data, the instructions cause the at least one processor to: receive the user profile data independent of transmitting a user profile request or an advertisement message to a user associated with the user profile data.

Clause 46: The computer program product of any of clauses 33-45, wherein, when receiving the user profile data, the instructions cause the at least one processor to: receive the user profile data via a chatbot interface.

Clause 47: The computer program product of any of clauses 33-46, wherein the instructions further cause the at least one processor to: receive merchant profile data for each merchant of the plurality of merchants, the merchant profile data comprising merchant offer data; and store the merchant profile data in the database; wherein, when inputting the interest preference data into the machine learning algorithm to generate at least one match between the user and the at least one merchant of a plurality of merchants, the instructions cause the at least one processor to: input the interest preference data into the machine learning algorithm and merchant profile data for a merchant of the plurality of merchants to generate at least one match between the user and the at least one merchant of a plurality of merchants.

Clause 48: The computer program product of any of clauses 33-47, wherein, when distributing the corresponding data sharing message to each merchant system associated with each merchant associated with the subset of the data associated with the at least one merchant, the instructions cause the at least one processor to: distribute the corresponding data sharing message to each merchant system associated with each merchant associated with the subset of the data associated with the at least one merchant based on determining that the user has provided an indication of an access grant.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the present disclosure are explained in greater detail below with reference to the exemplary embodiments that are illustrated in the accompanying figures, in which:

FIG. 1 is a diagram of a non-limiting embodiment or aspect of an environment in which systems, devices, products, apparatus, and/or methods, described herein, may be implemented, according to the principles of the present disclosure;

FIG. 2A is a flowchart of a non-limiting embodiment or aspect of a process for improving matching algorithms;

FIG. 2B is a flowchart of a non-limiting embodiment or aspect of a process for generating a data sharing message;

FIGS. 3A-3F are schematic diagrams of an exemplary implementation of a system and/or method for improving matching algorithms, according to some non-limiting embodiments or aspects;

FIG. 4 is a diagram of an exemplary environment in which systems, methods, and/or computer program products, described herein, may be implemented, according to some non-limiting embodiments or aspects;

FIG. 5 is a schematic diagram of example components of one or more devices of FIG. 1 and/or FIG. 4, according to some non-limiting embodiments or aspects;

FIGS. 6A-6E are a series of display screens for avoiding spam offers, according to some non-limiting embodiments or aspects;

FIGS. 7A-7C are a series of display screens for protection from phishing scams, according to some non-limiting embodiments or aspects;

FIGS. 8A-8D are a series of display screens for acquiring a loan, according to some non-limiting embodiments or aspects; and

FIGS. 9A-9K are a series of display screens for booking travel, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more point-of-sale (POS) devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), personal digital assistants (PDAs), and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the present disclosure are directed to methods, systems, and computer program products for improving matching algorithms. For example, non-limiting embodiments or aspects comprise receiving interest preference data, and this data may be received from a user device of the user. Receipt of this data enables more accurate matches by the matching algorithm because interest preference data specified directly by the user enables the matching algorithm to analyze updated preference data most relevant to that user, thus improving the matches and the efficiency with which they are generated. The interest preference data may be collected during a user-merchant transaction using a white label configured user interface that displays an interface marked by the merchant while enabling the interest preference data to be provided (e.g., directly) to a central system for collecting interest preference data (e.g., a transaction processing system). Thus, the white label configured user interface and the user's interaction therewith enables temporally-relevant data to be collected during a payment transaction, while reducing processing resources expended by the merchant system.

Non-limiting embodiment or aspects continually train the matching algorithm. For example, the user may provide feedback data via an interface of the user device regarding the relevance of certain offer communications as a result of the matching algorithm, and this feedback data may be input to the matching algorithm to further train and improve the matching algorithm.

Non-limiting embodiments or aspects provide users with more control over their interest preference data by the user configuring and providing privacy settings data. The privacy settings data may restrict sharing of at least a portion of the user's interest preference data, thus enabling the system to distribute the user's interest preference data in a more targeted manner, while restricting the distribution of this data according to the user-specified privacy settings. Thus, the system enhances control and dissemination of a user's private interest preference data.

Non-limiting embodiments or aspects generate a matching system that generates and transmits offers with enhanced relevance based on the initial receipt of consented user interest data and then update the user interest data on an ongoing basis, all of which may be received directly from the user. This direct communication between the matching system and the user allows for the qualitative enhancement of the suggested matches generated by the matching system. Thus, the user may receive fewer or no irrelevant offers. Further, the user control over the dissemination of their interest data provides enhanced privacy and control to the user.

In this way, contrary to typical search experiences, the machine learning system gives more weight to what a consumer wants (e.g., has expressed a desire for based on data that is provided by the consumer and/or inferred with regard to the consumer) as opposed to what a merchant and/or an aggregator is trying to supply to the consumer.

Further, the machine learning system uses data associated with the consumer to enrich the search signal and data associated with declared intent of the consumer with transaction history data and/or other data sources (e.g. identity providers) so that offers provided to the consumer are more pertinent (e.g., the offers fit within a comfort level of pricing sensitivity, match the brand affinity identified by past spending of a consumer, etc.). With this, the offers provide to a consumer lead to higher conversion rates because of the exceptional relevance of an offer provided by the machine learning system.

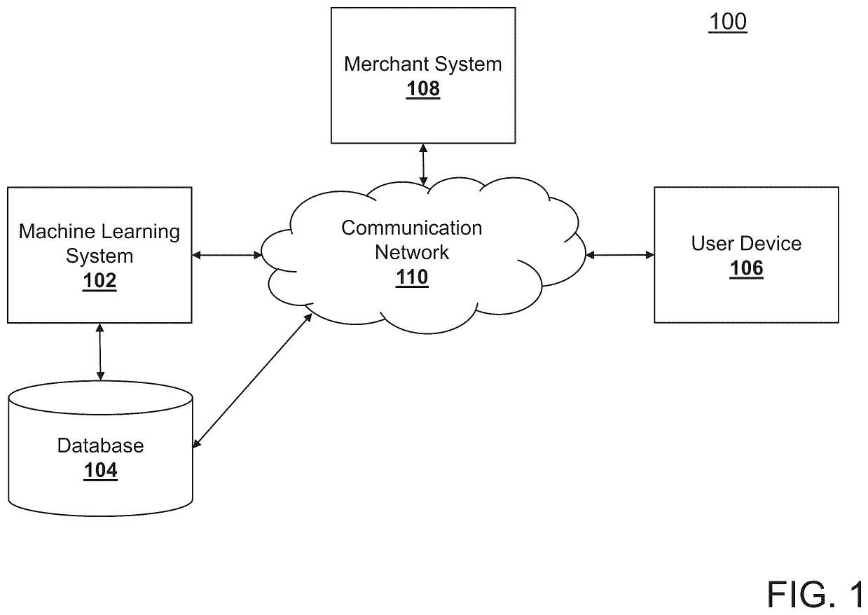

Referring now to FIG. 1, FIG. 1 is a diagram of example system 100 in which devices, systems, and/or methods, described herein, may be implemented. As shown in FIG. 1, system 100 includes machine learning system 102, database 104, user device 106, merchant system 108, and communication network 110. Machine learning system 102, database 104, user device 106, and/or merchant system 108 may interconnect (e.g., establish a connection to communicate) via wired connections, wireless connections, or a combination of wired and wireless connections.

Machine learning system 102 may include one or more devices capable of receiving information from and/or communicating information (e.g., directly via wired or wireless communication connection, indirectly via communication network 110, and/or the like) to database 104, user device 106, and/or merchant system 108 via communication network 110. For example, machine learning system 102 may include a server, a group of servers, a cloud platform, and/or other like devices. In some non-limiting embodiments or aspects, machine learning system 102 may be associated with a transaction service provider system. For example, machine learning system 102 may be operated by a transaction service provider system. In another example, machine learning system 102 may be a component of user device 106 and/or merchant system 108. In another example, machine learning system 102 may include database 104. In some non-limiting embodiments or aspects, machine learning system 102 may be in communication with a data storage device (e.g., database 104), which may be local or remote to machine learning system 102. In some non-limiting embodiments or aspects, machine learning system 102 may be capable of receiving information from, storing information in, transmitting information to, and/or searching information stored in the data storage device.

In some non-limiting embodiments or aspects, machine learning system 102 may include one or more (e.g., a plurality of) applications (e.g., software applications) that perform a set of functionalities on an external application programming interface (API) to send data to an external system (e.g., user device 106 or merchant system 108) associated with the external API and to receive data from the external system associated with the external API. In some non-limiting embodiments or aspects, machine learning system 102 may include one or more subsystems. For example, machine learning system 102 may include one or more subsystems that pertain to generation of one or more machine learning models (e.g., one or more matching machine learning models).

In some non-limiting embodiments or aspects, machine learning system 102 may generate (e.g., train, validate, re-train, and/or the like), store, and/or implement (e.g., operate, provide inputs to and/or outputs from, and/or the like) one or more machine learning models. For example, machine learning system 102 may generate one or more machine learning models by fitting (e.g., validating, testing, etc.) one or more machine learning models against data used for training (e.g., training data). In some non-limiting embodiments or aspects, machine learning system 102 may generate, store, and/or implement one or more machine learning models that are provided for a production environment (e.g., a runtime environment, a real-time environment, an environment where software applications and/or services are deployed and made available to end users, etc.) used for providing inferences (e.g., secure inferences) based on data inputs in a live situation (e.g., real-time situation, such as a time at which or close to a time at which operations, such as operations of machine learning system 102 or other system or device, are carried out) in a production environment. In some non-limiting embodiments or aspects, a production environment may include an information technology (IT) setup comprising hardware and/or software executed on hardware for reliability and redundancy. Additionally or alternatively, machine learning system 102 may generate, store, and/or implement one or more machine learning models that are provided for a non-production environment (e.g., an offline environment, a training environment, etc.) used for providing inferences based on data inputs in a situation that is not live.

In some non-limiting embodiments or aspects, machine learning system 102 may provide services (e.g., platform level services) that include services for isolated software instances, user interfaces for interaction, services associated with a marketplace for all aspects of merchant offers, services associated with access to machine learning system 102, services for consumption monitoring and/or billing associated with use of machine learning system 102, services for onboarding users of machine learning system 102, procurement services related to machine learning system 102, and/or user management services (e.g., authentication, authorization, levels of access, etc.) related to machine learning system 102.

Database 104 may include one or more devices capable of receiving information from and/or communicating information (e.g., directly via wired or wireless communication connection, indirectly via communication network 110, and/or the like) to machine learning system 102 and/or user device 106. For example, database 104 may include a server, a group of servers, a desktop computer, a portable computer, a mobile device, and/or other like devices. In some non-limiting embodiments or aspects, database 104 may include a data storage device. In some non-limiting embodiments or aspects, database 104 may be capable of receiving information from, storing information in, communicating information to, or searching information stored in the data storage device. In some non-limiting embodiments or aspects, database 104 may be part of machine learning system 102 and/or part of the same system as machine learning system 102.

User device 106 may include one or more devices capable of receiving information from and/or communicating information (e.g., directly via wired or wireless communication connection, indirectly via communication network 110, and/or the like) to machine learning system 102 and/or database 104. For example, user device 106 may include a computing device, such as a mobile device, a portable computer, a desktop computer, and/or other like devices. Additionally or alternatively, user device 106 may include a device capable of receiving information from and/or communicating information to other user devices (e.g., directly via wired or wireless communication connection, indirectly via communication network 110, and/or the like). In some non-limiting embodiments or aspects, user device 106 may be part of machine learning system 102 and/or part of the same system as machine learning system 102. For example, machine learning system 102, database 104, and user device 106 may all be (and/or be part of) a single system and/or a single computing device.

Merchant system 108 may include one or more devices capable of receiving information from and/or communicating information (e.g., directly via wired or wireless communication connection, indirectly via communication network 110, and/or the like) to machine learning system 102, database 104, and/or user device 106 via communication network 110. For example, merchant system 108 may include a server, a group of servers, a cloud platform, and/or other like devices. In some non-limiting embodiments or aspects, machine learning system 102 may be associated with a merchant. For example, machine learning system 102 may be operated by a merchant system 108. In some non-limiting embodiments or aspects, merchant system 108 may include memory, one or more storage components, one or more input components, one or more output components, and/or one or more communication interfaces, as described herein.

Communication network 110 may include one or more wired and/or wireless networks. For example, communication network 110 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

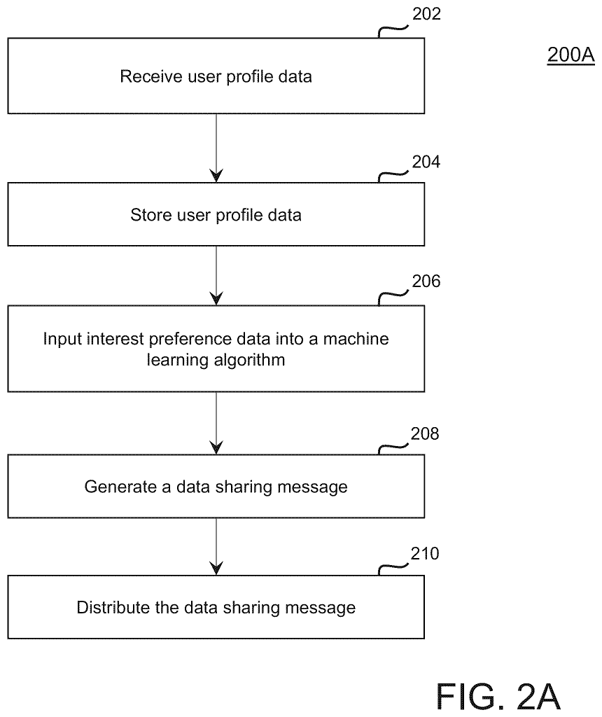

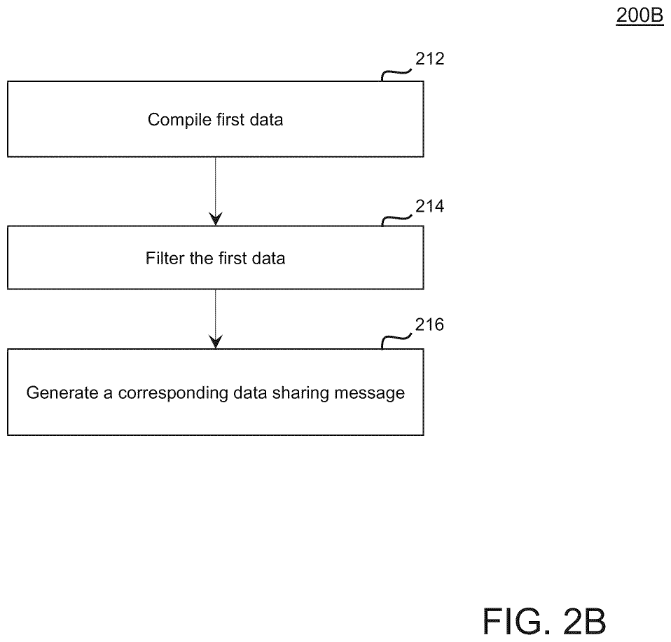

Referring now to FIG. 2A, shown is a flow diagram for process 200A for improving matching algorithms, according to some non-limiting embodiments or aspects. In some non-limiting embodiments or aspects, one or more of the steps of process 200A may be performed (e.g., completely, partially, etc.) by machine learning system 102 (e.g., one or more devices of machine learning system 102). In some non-limiting embodiments or aspects, one or more of the steps of process 200A may be performed (e.g., completely, partially, etc.) by another device or a group of devices separate from or including machine learning system 102 (e.g., one or more devices of machine learning system 102), database 104, user device 106, and/or merchant system 108. The steps shown in FIG. 2A are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2A, at step 202, process 200A may include receiving user profile data (e.g., from user device 106) comprising privacy settings data and interest preference data of a user. For example, machine learning system 102 may receive the user profile data (e.g., from database 104, user device 106, and/or merchant system 108). In some non-limiting embodiments or aspects, machine learning system 102 may receive the user profile data based on a user input provide to a user interface displayed on user device 106. For example, a user may provide one or more user inputs to a chatbot via a user interface displayed on user device 106. In some non-limiting embodiments or aspects, the chatbot may be operated by the same entity that operates machine learning system 102. In some non-limiting embodiments or aspects, the user profile data may be combined with data from other data sources (e.g., access to data which the consumer has consented), such as their identity data, loyalty program data, and/or the like.

In some non-limiting embodiments or aspects, privacy data settings may include a restriction on sharing at least a portion of interest preference data of a user and/or historical user transaction data. The interest preference data (e.g., user interest preference data) may include any data indicating an interest of the user, such as at least one of a preferred or non-preferred merchant or merchant category, a preferred offer timing, a user spend estimate (e.g., generally, or specific to a certain merchant or merchant category), and a user financial profile. The interest preference data may be received based on user input and/or may be inferred based on user activity (e.g., user transaction activity). The interest data may include a list of acceptable merchants, historical transaction data, financial products connected to user accounts, user account data, types of acceptable transactions, fund limit per transaction, general spend or merchant category spend or merchant/brand spend, timing and/or frequency of spend, requested timing and/or frequency of offers, merchants and/or merchant categories from which offers are acceptable/unacceptable, user credit score, and the like. For business entities, interest data may include or further include business data, recent transaction history (e.g., sales and/or purchases), business credit score, business type, business sector, business client data, business cost structure and/or seasonality, loan amount requested, existing financial obligations, requested payback period, auto-debit data, requested loan rate, and the like. The historical user transaction data may comprise transaction data associated with payment transactions (e.g., electronic payment transactions) conducted involving the user.

In some non-limiting embodiments or aspects, transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a personal identification number (PIN), etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some non-limiting embodiments or aspects, data received from user device 106 (e.g., user profile data, feedback data, and the like) may pass through several additional layers before, during, or after being input to machine learning system 102. For example, the data from user device 106 may pass through a delivery partner website and/or mobile application which embeds a white label configured user interface. The data may also be processed by underlying microservices to capture the received data. The received data may also be stored in a database.

In some non-limiting embodiments or aspects, machine learning system 102 may receive a request for access data associated with a user of user device 106 (e.g., from merchant system 108), determine whether the request for access complies with one or more criteria associated with access to the data, and provide access to the data based on determining that the request for access complies with one or more criteria associated with access to the particular dataset. In some non-limiting embodiments or aspects, machine learning system 102 may determine that the request for access complies with the criteria based on user identification information (e.g., a username, a password, an identification number, a device identifier associated with user device 106, such as an internet protocol (IP) address, media access control (MAC) address, etc.). For example, machine learning system 102 may determine whether the user identification information, provided as part of the access request, matches the one or more criteria associated with access to the particular data. Machine learning system 102 may determine that the user identification information matches additional user identification information stored in a data structure (e.g., database 104). In some non-limiting embodiments or aspects, if machine learning system 102 determines that the request for access complies with the one or more criteria, then merchant system 108 may be provided with access to the particular data. If machine learning system 102 determines that the request for access does not comply with the one or more criteria, then merchant system 108 may not be provided with access to the particular data. In some non-limiting embodiments, the one or more criteria associated with access to the particular dataset may include whether merchant system 108 has access to a subscription associated with the particular data. In some non-limiting embodiments or aspects, when providing access to the particular data, machine learning system 102 may perform an API call associated with the particular data to database 104 to provide access to the particular data. In some non-limiting embodiments or aspects, the data can only be accessed by merchant system 108 in accordance with a user's consent.

As shown in FIG. 2A, at step 204, process 200A may include storing user profile data in a database, the user profile data comprising the privacy settings data and interest preference data of the user. For example, machine learning system 102 may store the user profile data in database 104.

As shown in FIG. 2A, at step 206, process 200A may include inputting the interest preference data into a machine learning algorithm. For example, machine learning system 102 may input the interest preference data into the machine learning algorithm (e.g., a machine learning model) to generate at least one match between the user and at least one merchant of a plurality of merchants. For example, machine learning system 102 may input the interest preference data into a machine learning algorithm to generate at least one match between the user and at least one merchant of a plurality of merchants. In some non-limiting embodiments or aspects, the at least one merchant may include a subset of the plurality of merchants. In some non-limiting embodiments or aspects, the machine learning algorithm, may include a machine learning model, which may include a large language model (LLM) that is configured to output a text response to an input (e.g., an input prompt) that includes the interest preference data of the user associated with user device 106. In some non-limiting embodiments or aspects, the LLM may be a part of a generative artificial intelligence (AI) model. In some non-limiting embodiments, the generative AI model may be a part of a generative AI system.

In some non-limiting embodiments or aspects, the interest preference data may be input by machine learning system 102 to generate at least one match between the user and at least one merchant of a plurality of merchants. In some non-limiting embodiments or aspects, machine learning system 102 may generate no matches for the user in the event that machine learning system 102 determines that the matches are of an insufficient quality, such as by potential matches not satisfying a matching threshold based on a matching score. A potential match having a matching score satisfying the matching threshold may cause the potential match to be transmitted to the user and/or to a merchant.

As shown in FIG. 2A, at step 208, process 200A may include generating a data sharing message. For example, machine learning system 102 may generate at least one data sharing message based on the at least one match. In some non-limiting embodiments or aspects, the data sharing message may include interest preference data, privacy settings data, and/or transaction data associated with the user associated with user device 106. In some non-limiting embodiments or aspects, machine learning system 102 may generate a data sharing message so that the data sharing message is formatted according to merchant system 108. For example, machine learning system 102 may generate the data sharing message so that the data sharing message is formatted according to an API of merchant system 108.

In some non-limiting embodiments or aspects, machine learning system 102 may generate a data sharing message according to steps 212-216, as shown with regard to FIG. 2B.

As shown in FIG. 2A, at step 210, process 200A may include distributing the data sharing message. For example, machine learning system 102 may distribute the data sharing message to each merchant system 108 associated with each merchant regarding the subset of the data associated with the at least one merchant. For example, machine learning system 102 may distribute corresponding data sharing messages to each of a plurality of merchant systems 108 based on data associated with each merchant included in a match provided by the machine learning algorithm.

In some non-limiting embodiments or aspects, machine learning system 102 may prevent distribution of the interest preference data to merchants (e.g., merchant systems 108 thereof) of a plurality of merchants that are not associated with the subset of the data associated with the at least one merchant (e.g., data associated with at least one merchant that is associated with a match of the machine learning algorithm).

In some non-limiting embodiments or aspects, machine learning system 102 may cause a user interface (e.g., a white label configured user interface) to display on user device 106 through merchant system 108 during a transaction between the user and merchant system 108. In some non-limiting embodiments or aspects, machine learning system 102 may receive user profile data in response to the user engaging the user interface.

In some non-limiting embodiments or aspects, machine learning system 102 may receive merchant profile data for each merchant of a plurality of merchants. In some non-limiting embodiments or aspects, the merchant profile data may include merchant preference data. In some non-limiting embodiments or aspects, machine learning system 102 may input the merchant profile data into the machine learning algorithm, and machine learning system 102 may generate at least one match (e.g., as an output) between the user and at least one merchant based on the interest preference data and the merchant preference data. In some non-limiting embodiments or aspects, the merchant profile data may include data associated with products offered by a merchant (e.g., a product catalog, a list of goods and/or services, etc.)

In some non-limiting embodiments or aspects, machine learning system 102 may cause a feedback user interface to display on user device 106. For example, machine learning system 102 may cause a feedback user interface to display on user device 106 in response to user device 106 receiving a first offer from a merchant to which a data sharing message was distributed. In some non-limiting embodiments or aspects, the feedback user interface may include at least one selectable element. In some non-limiting embodiments or aspects, machine learning system 102 may receive feedback data from user device 106 based on a user input to the feedback user interface by the user interacting with the at least one selectable element. In some non-limiting embodiments or aspects, machine learning system 102 may input the feedback data to machine learning system 102 to further train the machine learning algorithm. In some non-limiting embodiments or aspects, the feedback data may include attribution data, meaning those signals which did end up moving through for purchase can be traced, as well as (more importantly) the signals that were not matched and checked out. This can help merchants understand what worked and what did not about their offerings to various segments of market/consumers, so they can alter their messages and or pricing accordingly.

In some non-limiting embodiments or aspects, machine learning system 102 may compile a plurality of offers for the user from a plurality of merchants to which a data sharing message was distributed and generate an offer (e.g., offers) message that includes a plurality of offers (e.g., a plurality of offers that have been compiled, for example, by machine learning system 102). In some non-limiting embodiments or aspects, machine learning system 102 may transmit the offer message to user device 106 based on receiving and/or compiling the plurality of offers for the user from each merchant system associated with the plurality of merchants.

In some non-limiting embodiments or aspects, machine learning system 102 may receive updated user profile data comprising updated interest preference data, updated privacy settings data, and/or updated historical user transaction data (e.g., from user device 106). In some non-limiting embodiments or aspects, machine learning system 102 may store and/or replace, in database 104, the interest preference data and privacy settings data with the updated interest preference data, updated privacy settings data, and/or updated historical user transaction data. The updated user interest data may include historical transaction data of recent payment transactions engaged in by the user (e.g., provided by user device 106). The historical transaction data may be automatically submitted by user device 106 linking an issuer system associated with payment devices of the user to machine learning system 102, so that the issuer system transmits the user's historical transaction data directly or indirectly to machine learning system 102.

In some non-limiting embodiments or aspects, the interest preference data may comprise a list of user-approved merchants. In some non-limiting embodiments or aspects, machine learning system 102 may, in response to user device 106 receiving a message, automatically determine that a message is not from a merchant on the list of user-approved merchants and may cause a display of user device 106 to display a user-selectable warning element.

In some non-limiting embodiments or aspects, the interest preference data may comprise loan parameters. In some non-limiting embodiments or aspects, machine learning system 102 may receive merchant profile data for each merchant (e.g., each merchant of a plurality of merchants associated with a plurality of merchant systems 108) of a plurality of merchants. The merchant profile data may include loan offer data. In some non-limiting embodiments or aspects, machine learning system 102 may input the loan offer data into the machine learning algorithm of machine learning system 102 and generate, with the machine learning algorithm, the at least one match between the user and at least one merchant based on the loan parameters and the loan offer data. The loan parameters may include any parameter associated with underwriting a loan, such as an acceptable and/or unacceptable interest rate.

In some non-limiting embodiments or aspects, machine learning system 102 may generate a suggested action for the user based on the interest preference data and/or a suggestion message including the suggestion action. In some non-limiting embodiments or aspects, machine learning system 102 may transmit the suggestion message to user device 106 of the user to cause the suggestion action to be displayed on a user interface on user device 106. The suggested action may be generated by a machine-learning algorithm based on the interest preference data as an input. The user's historical transaction data may also be an input thereto. The suggested action may be generated by a generative artificial intelligence system. The suggested action may include a recommendation to renew and/or cancel a periodic subscription, increase, or reduce spend in a specific merchant category, a suggestion for a product or service and/or financial product or service, and/or the like.

Referring now to FIG. 2B, shown is a flow diagram for process 200B for generating the at least one data sharing message, according to some non-limiting embodiments or aspects. The steps shown in FIG. 2B are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2B, at step 212, process 200B may include compiling first data. For example, when generating the at least one data sharing message, machine learning system 102 may compile first data associated with the user. In some non-limiting embodiments or aspects, the first data may include the interest preference data and/or data associated with the at least one merchant.

As shown in FIG. 2B, at step 214, process 200B may include filtering the first data. For example, when generating the at least one data sharing message, machine learning system 102 may filter the first data based on at least one of the interest preference data and the privacy settings data to generate shareable data comprising a subset of at least one of the interest preference data and the data associated with the at least one merchant.

As shown in FIG. 2B, at step 216, process 200B may include generating a corresponding data sharing message. For example, when generating the at least one data sharing message, machine learning system 102 may, for each merchant associated with the subset of the data associated with the at least one merchant, generate a corresponding data sharing message containing the subset of interest preference data.

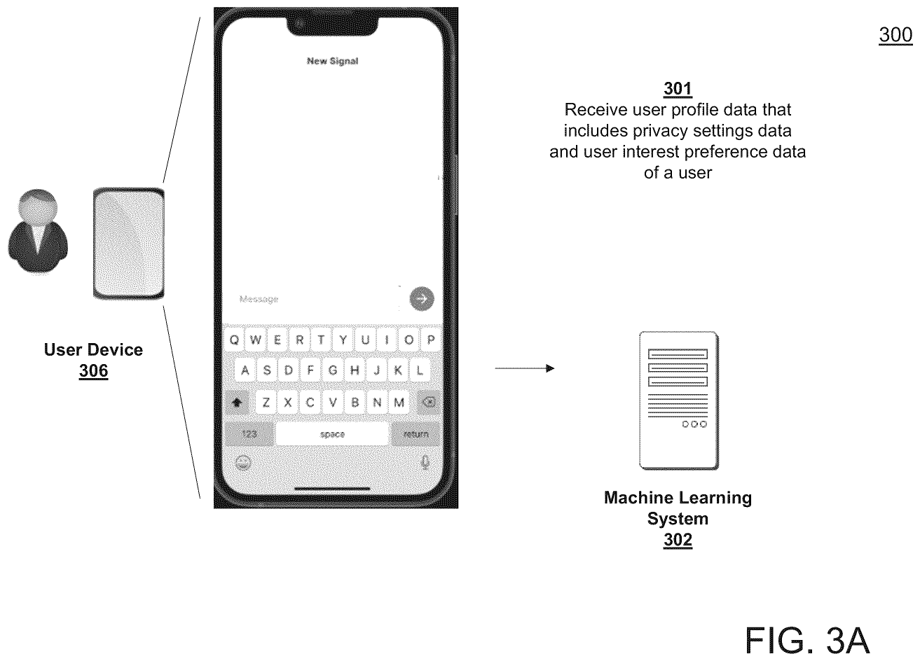

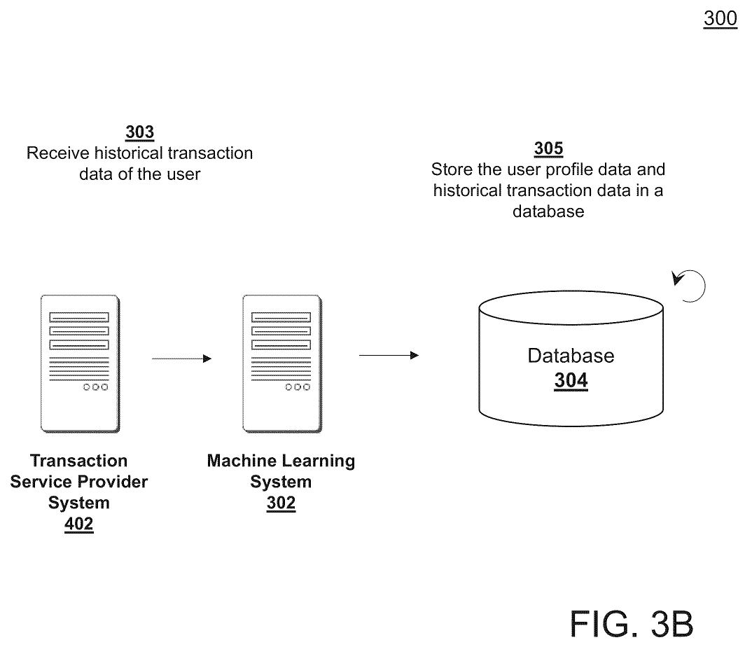

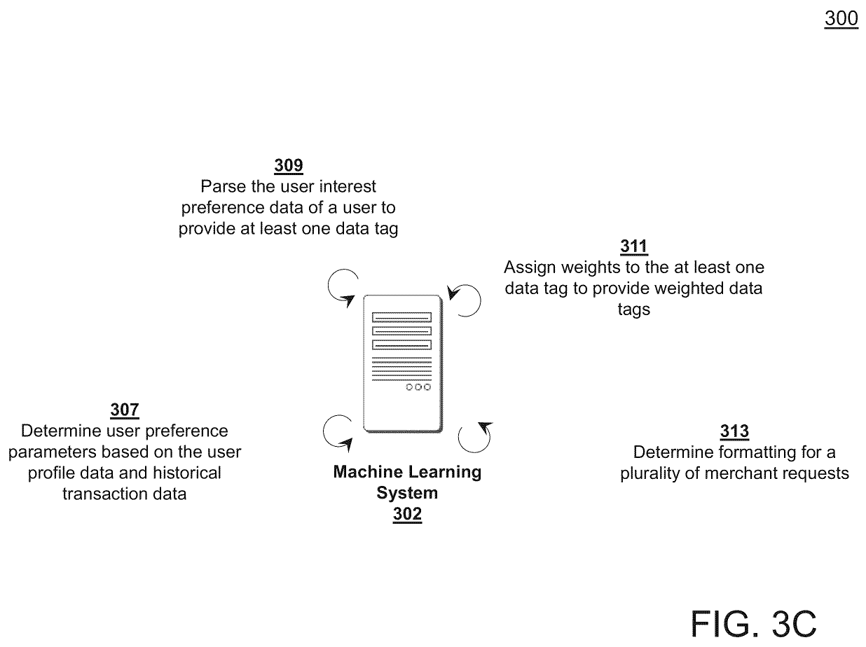

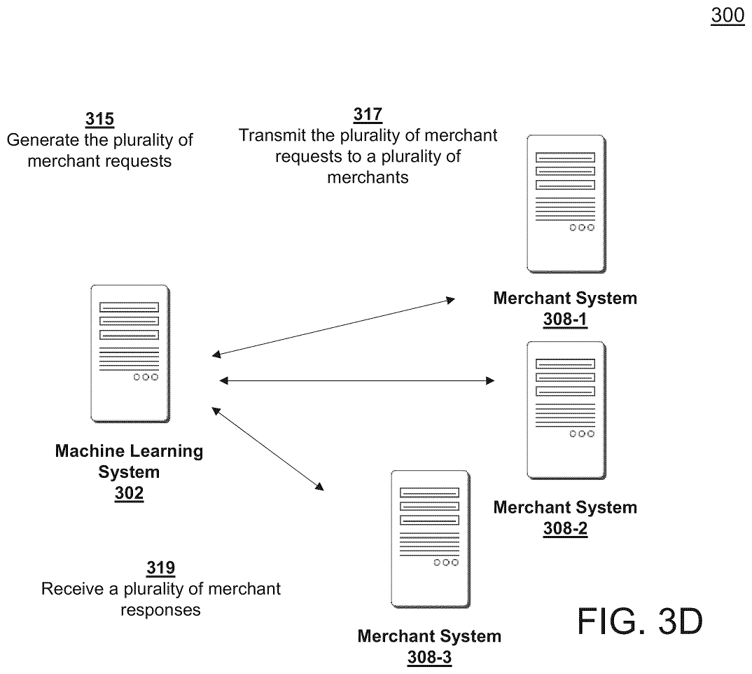

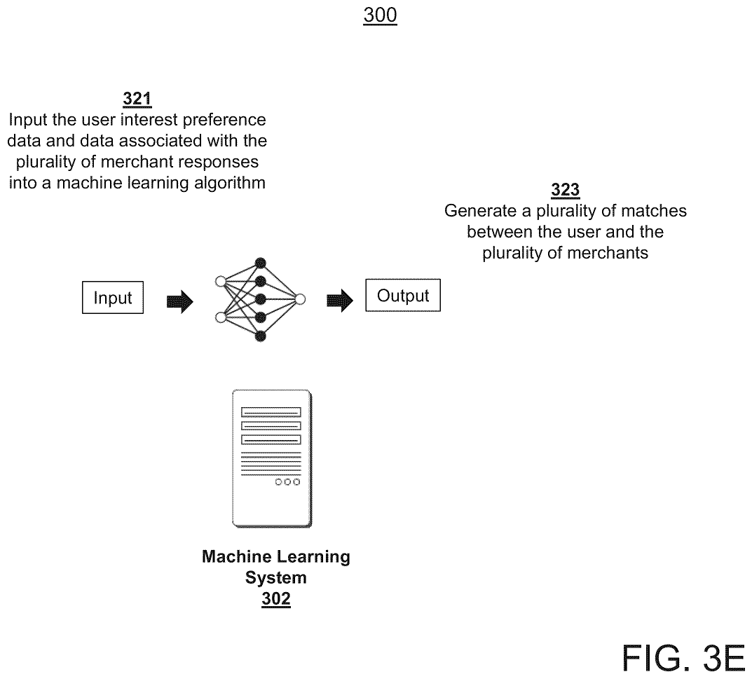

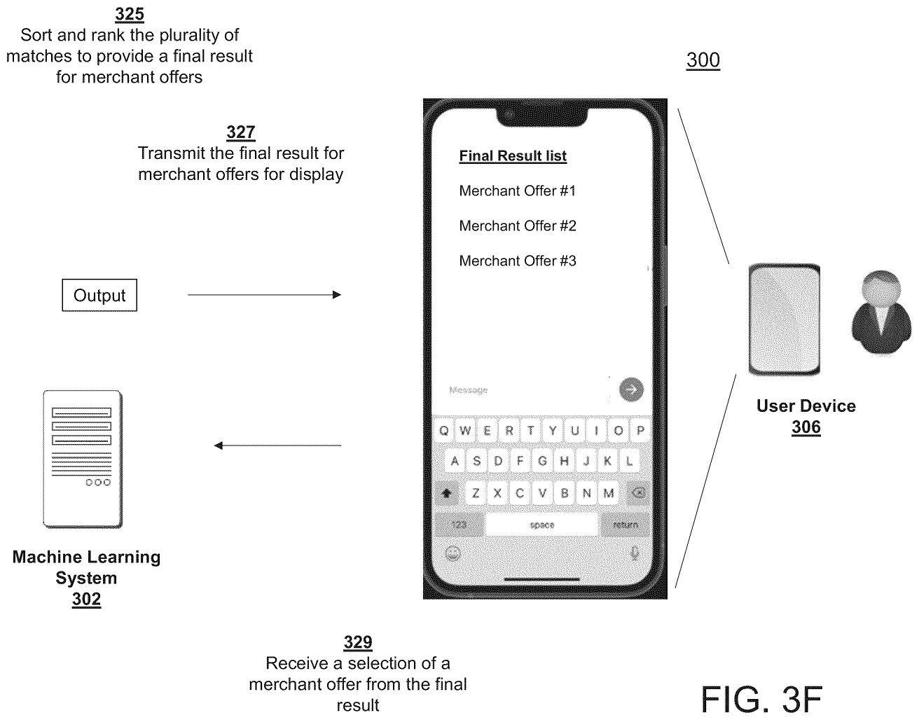

Referring now to FIGS. 3A-3F, shown are schematic diagrams of implementation 300 of a process (e.g., process 200) for improving matching algorithms. In some non-limiting embodiments or aspects, one or more of the steps of the process may be performed (e.g., completely, partially, etc.) by machine learning system 102 (e.g., one or more devices of machine learning system 102). In some non-limiting embodiments or aspects, one or more of the steps of the process may be performed (e.g., completely, partially, etc.) by another device or a group of devices separate from or including machine learning system 302, database 304, user device 306, transaction service provider system 402, and/or merchant systems 308-1 through 308-3.

In some non-limiting embodiments or aspects, machine learning system 302 may be the same as, similar to, and/or party of machine learning system 102. In some non-limiting embodiments or aspects, user device 306 may be the same as, similar to, and/or part of user device 106. In some non-limiting embodiments or aspects, database 304 may be the same as, similar to, and/or part of database 104. In some non-limiting embodiments or aspects, merchant systems 308-1, 308-2, and/or 308-3 may be the same as, similar to, and/or part of merchant system 108.

As shown by reference number 301 in FIG. 3A, machine learning system 302 may receive user profile data that includes privacy settings data and user interest preference data of a user. In some non-limiting embodiments or aspects, the interest preference data may include at least one of a preferred or a non-preferred merchant, a preferred offer timing, a user spend estimate, a user financial profile, one or more activities of the user, and/or one or more objectives of the user. In some non-limiting embodiments or aspects, the interest preference data may include loan parameters.

In some non-limiting embodiments or aspects, the privacy settings data may include a restriction on sharing at least a portion of the interest preference data and/or historical user transaction data of the user.

In some non-limiting embodiments or aspects, machine learning system 302 may cause a white label configured user interface to display on user device 306 through a merchant system during a transaction between the user and the merchant system. In some non-limiting embodiments or aspects, machine learning system 302 may receive the user profile data in response to the user engaging the white label configured user interface.

In some non-limiting embodiments or aspects, machine learning system 302 may receive the user profile data independent of transmitting a user profile request or an advertisement message to a user associated with the user profile data. In some non-limiting embodiments or aspects, machine learning system 302 may receive the user profile data via a chatbot interface.

As shown by reference number 303 in FIG. 3B, machine learning system 302 may receive historical transaction data of the user from transaction service provider system 402.

As further shown by reference number 305 in FIG. 3B, machine learning system 302 may store the user profile data and historical transaction data in database. In some non-limiting embodiments or aspects, machine learning system 302 may receive user profile data from a source that has proactively been added as an accessible source. In some non-limiting embodiments or aspects, machine learning system 302 may receive, via user device 306, updated user profile data comprising updated interest preference data, updated privacy settings data, and/or updated historical user transaction data. In some non-limiting embodiments or aspects, machine learning system 302 may store and/or replace, in database 304, the interest preference data and privacy settings data with the updated interest preference data, the updated privacy settings data, and/or the updated historical user transaction data. In some non-limiting embodiments or aspects, machine learning system 302 may receive merchant profile data for each merchant of the plurality of merchants. The merchant profile data may include merchant offer data. In some non-limiting embodiments or aspects, machine learning system 302 may store the merchant profile data in database 304.

As shown by reference number 307 in FIG. 3C, machine learning system 302 may determine user preference parameters based on the user profile data and historical transaction data. As further shown by reference number 309 in FIG. 3C, machine learning system 302 may parse the user interest preference data of a user to provide at least one data tag.

As further shown by reference number 311 in FIG. 3C, machine learning system 302 may assign weights to the at least one data tag to provide weighted data tags. As further shown by reference number 313 in FIG. 3C, machine learning system 302 may determine formatting for a plurality of merchant requests. In some non-limiting embodiments or aspects, machine learning system 302 may apply different weights to different aspects of data associated with a consumer's intent based on a specific use case to improve a ranking of what a consumer may see in a result. In some non-limiting embodiments or aspects, machine learning system 302 may apply weights towards any situation where supply and demand are to be matched. In some non-limiting embodiments or aspects, machine learning system 302 may start out with initial weights that are configured for data tags that are both industry specific and/or in part based on sentiment analysis. Over time and with more usage, a consumer may elect to change the weights with each of the data tags based on what the consumer finds to be important. In some non-limiting embodiments or aspects, machine learning system 302 may incorporate data associated with weights provided by a consumer into feedback data.

As shown by reference number 315 in FIG. 3D, machine learning system 302 may generate the plurality of merchant requests. As further shown by reference number 317 in FIG. 3D, machine learning system 302 may transmit the plurality of merchant requests to a plurality of merchants (e.g., merchant systems 308-1, 308-2, and/or 308-3). As further shown by reference number 319 in FIG. 3D, machine learning system 302 may receive a plurality of merchant responses (e.g., from merchant systems 308-1, 308-2, and/or 308-3).

As shown by reference number 321 in FIG. 3E, machine learning system 302 may input the user interest preference data and data associated with the plurality of merchant responses into a machine learning algorithm. In some non-limiting embodiments or aspects, when inputting the interest preference data into the machine learning algorithm to generate at least one match between the user and the at least one merchant of a plurality of merchants, machine learning system 302 may input the interest preference data into the machine learning algorithm and merchant profile data for a merchant of the plurality of merchants to generate at least one match between the user and the at least one merchant of the plurality of merchants. As further shown by reference number 323 in FIG. 3E, machine learning system 302 may generate a plurality of matches between the user and the plurality of merchants.

In some non-limiting embodiments or aspects, machine learning system 302 may input the user interest preference data and data associated with the plurality of merchant responses into the machine learning algorithm to generate at least one match between the user and at least one merchant of the plurality of merchants. In some non-limiting embodiments or aspects, the at least one merchant may include a subset of the plurality of merchants. In some non-limiting embodiments or aspects, machine learning system 302 may receive merchant profile data for each merchant of the plurality of merchants. The merchant profile data may include merchant preference data.

In some non-limiting embodiments or aspects, machine learning system 302 may input the merchant profile data into the machine learning algorithm. In some non-limiting embodiments or aspects, machine learning system 302 may generate the at least one match between the user and at least one merchant using the machine learning algorithm based on the interest preference data and the merchant preference data.

In some non-limiting embodiments or aspects, where the interest preference data includes loan parameters, machine learning system 302 may receive merchant profile data for each merchant of the plurality of merchants, where the merchant profile data includes loan offer data. In some non-limiting embodiments or aspects, machine learning system 302 may input the loan offer data into the machine learning algorithm. In some non-limiting embodiments or aspects, machine learning system 302 may generate the at least one match between the user and the at least one merchant using the machine learning algorithm based on the loan parameters and the loan offer data.

As shown by reference number 325 in FIG. 3F, machine learning system 302 may sort and rank the plurality of matches to provide a final result for merchant offers. As further shown by reference number 327 in FIG. 3F, machine learning system 302 may transmit the final result for merchant offers for display via user device 306.

In some non-limiting embodiments or aspects, machine learning system 302 may generate at least one data sharing message. When generating the at least one data sharing message, machine learning system 302 may compile first data associated with the user, the first data including the interest preference data and data associated with the at least one merchant. When generating the at least one data sharing message, machine learning system 302 may filter the first data based on at least one of the interest preference data and the privacy settings data to generate shareable data comprising a subset of at least one of the interest preference data and the data associated with the at least one merchant. When generating the at least one data sharing message, machine learning system 302 may, for each merchant associated with the subset of the data associated with the at least one merchant, generate a corresponding data sharing message containing the subset of interest preference data.

In some non-limiting embodiments or aspects, machine learning system 302 may distribute the corresponding data sharing message to each merchant system (e.g., merchant systems 308-1, 308-2, and/or 308-3) associated with each merchant associated with the subset of the data associated with the at least one merchant. In some non-limiting embodiments or aspects, when distributing the corresponding data sharing message to each merchant system associated with each merchant associated with the subset of the data associated with the at least one merchant, machine learning system 302 may distribute the corresponding data sharing message to each merchant system (e.g., merchant systems 308-1, 308-2, and/or 308-3) associated with each merchant associated with the subset of the data associated with the at least one merchant based on determining that the user has provided an indication of an access grant.

In some non-limiting embodiments or aspects, machine learning system 302 may prevent distribution of the interest preference data to merchants of the plurality of merchants not associated with the subset of the data associated with the at least one merchant. In some non-limiting embodiments or aspects, the interest preference data may include a list of user-approved merchant. In some non-limiting embodiments or aspects, in response to user device 306 receiving a message, machine learning system 302 may automatically determine that the message is not from a merchant on the list of user-approved merchants. In some non-limiting embodiments or aspects, machine learning system 302 may cause a display of the device of the user to display a user-selectable warning element.

In some non-limiting embodiments or aspects, in response to user device 306 receiving a first offer from a merchant to which a data sharing message was distributed, machine learning system 302 may cause a feedback user interface to display on user device 306. The feedback user interface may include at least one selectable element. In some non-limiting embodiments or aspects, machine learning system 302 may receive feedback data from user device 306 based on a user input to the feedback user interface by the user interacting with the at least one selectable element. In some non-limiting embodiments or aspects, machine learning system 302 may input the feedback data to the machine learning algorithm to further train the machine learning algorithm.

In some non-limiting embodiments or aspects, machine learning system 302 may compile a plurality of offers for the user from a plurality of merchants to which a data sharing message was distributed. In some non-limiting embodiments or aspects, machine learning system 302 may generate an offers message including the compiled plurality of offers. In some non-limiting embodiments or aspects, machine learning system 302 may transmit the offers message to user device 306.

As further shown by reference number 329 in FIG. 3F, machine learning system 302 may receive a selection of a merchant offer from the final result from user device 306. In some non-limiting embodiments or aspects, machine learning system 302 may generate a suggested action for the user based on the interest preference data. In some non-limiting embodiments or aspects, machine learning system 302 may generate a suggestion message containing the suggested action. In some non-limiting embodiments or aspects, machine learning system 302 may transmit the suggestion message to user device 306 to cause the suggestion action to be displayed on a user interface on user device 306.

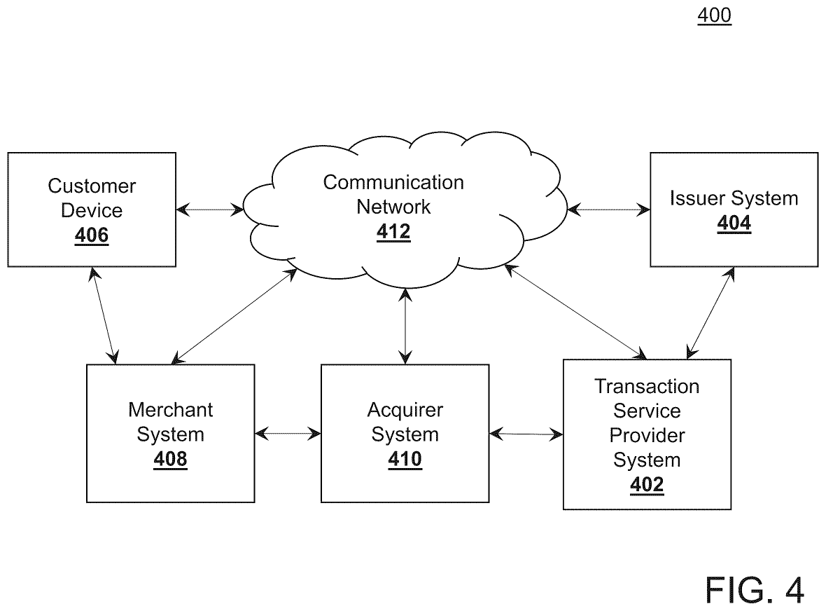

Referring now to FIG. 4, shown is a diagram of a non-limiting embodiment or aspect of exemplary environment 400 in which methods, systems, and/or products, as described herein, may be implemented. As shown in FIG. 4, environment 400 may include transaction service provider system 402, issuer system 404, customer device 406, merchant system 408, acquirer system 410, and communication network 412. In some non-limiting embodiments or aspects, each of machine learning system 102, database 104, user device 106, and merchant system 108 of FIG. 1 may be implemented by (e.g., part of) transaction service provider system 402. In some non-limiting embodiments or aspects, at least one of machine learning system 102, database 104, user device 106, and merchant system 108 of FIG. 1 may be implemented by (e.g., part of) another system, another device, another group of systems, or another group of devices, separate from or including transaction service provider system 402, such as issuer system 404, customer device 406, merchant system 408, acquirer system 410, and/or the like.

Transaction service provider system 402 may include one or more devices capable of receiving information from and/or communicating information to issuer system 404, customer device 406, merchant system 408, and/or acquirer system 410 via communication network 412. For example, transaction service provider system 402 may include a computing device, such as a server (e.g., a transaction processing server), a group of servers, and/or other like devices. In some non-limiting embodiments or aspects, transaction service provider system 402 may be associated with a transaction service provider, as described herein. In some non-limiting embodiments or aspects, transaction service provider system 402 may be in communication with a data storage device, which may be local or remote to transaction service provider system 402. In some non-limiting embodiments or aspects, transaction service provider system 402 may be capable of receiving information from, storing information in, communicating information to, or searching information stored in the data storage device.

Issuer system 404 may include one or more devices capable of receiving information and/or communicating information to transaction service provider system 402, customer device 406, merchant system 408, and/or acquirer system 410 via communication network 412. For example, issuer system 404 may include a computing device, such as a server, a group of servers, and/or other like devices. In some non-limiting embodiments or aspects, issuer system 404 may be associated with an issuer institution, as described herein. For example, issuer system 404 may be associated with an issuer institution that issued a credit account, debit account, credit card, debit card, and/or the like to a user associated with customer device 406.

Customer device 406 may include one or more devices capable of receiving information from and/or communicating information to transaction service provider system 402, issuer system 404, merchant system 408, and/or acquirer system 410 via communication network 412. Additionally or alternatively, each customer device 406 may include a device capable of receiving information from and/or communicating information to other customer devices 406 via communication network 412, another network (e.g., an ad hoc network, a local network, a private network, a virtual private network, and/or the like), and/or any other suitable communication technique. For example, customer device 406 may include a client device and/or the like. In some non-limiting embodiments or aspects, customer device 406 may or may not be capable of receiving information (e.g., from merchant system 408 or from another customer device 406) via a short-range wireless communication connection (e.g., an NFC communication connection, an RFID communication connection, a Bluetooth® communication connection, a Zigbee® communication connection, and/or the like), and/or communicating information (e.g., to merchant system 408) via a short-range wireless communication connection. In some non-limiting embodiments or aspects, customer device 406 may be the same as or similar to user device 106.

Merchant system 408 may include one or more devices capable of receiving information from and/or communicating information to transaction service provider system 402, issuer system 404, customer device 406, and/or acquirer system 410 via communication network 412. Merchant system 408 may also include a device capable of receiving information from customer device 406 via communication network 412, a communication connection (e.g., an NFC communication connection, an RFID communication connection, a Bluetooth® communication connection, a Zigbee® communication connection, and/or the like) with customer device 406, and/or the like, and/or communicating information to customer device 406 via communication network 412, the communication connection, and/or the like. In some non-limiting embodiments or aspects, merchant system 408 may include a computing device, such as a server, a group of servers, a client device, a group of client devices, and/or other like devices. In some non-limiting embodiments or aspects, merchant system 408 may be associated with a merchant, as described herein. In some non-limiting embodiments or aspects, merchant system 408 may include one or more client devices. For example, merchant system 408 may include a client device that allows a merchant to communicate information to transaction service provider system 402. In some non-limiting embodiments or aspects, merchant system 408 may include one or more devices, such as computers, computer systems, and/or peripheral devices capable of being used by a merchant to conduct a transaction with a user. For example, merchant system 408 may include a POS device and/or a POS system. In some non-limiting embodiments or aspects, merchant system 408 may be the same as or similar to merchant system 108.

Acquirer system 410 may include one or more devices capable of receiving information from and/or communicating information to transaction service provider system 402, issuer system 404, customer device 406, and/or merchant system 408 via communication network 412. For example, acquirer system 410 may include a computing device, a server, a group of servers, and/or the like. In some non-limiting embodiments or aspects, acquirer system 410 may be associated with an acquirer, as described herein.

Communication network 412 may include one or more wired and/or wireless networks. For example, communication network 412 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 4 are provided as an example. There may be additional systems, devices, and/or networks; fewer systems, devices, and/or networks; different systems, devices, and/or networks; and/or differently arranged systems, devices, and/or networks than those shown in FIG. 4. Furthermore, two or more systems or devices shown in FIG. 4 may be implemented within a single system or device, or a single system or device shown in FIG. 4 may be implemented as multiple, distributed systems or devices. Additionally or alternatively, a set of systems (e.g., one or more systems) or a set of devices (e.g., one or more devices) of environment 400 may perform one or more functions described as being performed by another set of systems or another set of devices of environment 400.

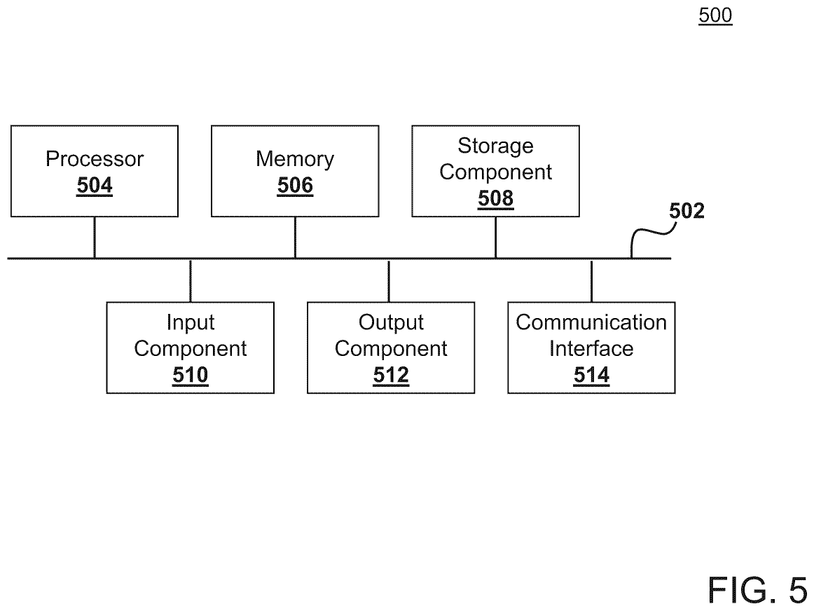

Referring now to FIG. 5, shown is a diagram of example components of device 500, according to non-limiting embodiments or aspects. Device 500 may correspond to at least one of machine learning system 102, database 104, user device 106, and merchant system 108 in FIG. 1 and/or at least one of transaction service provider system 402, issuer system 404, customer device 406, merchant system 408, and/or acquirer system 410 in FIG. 4, as an example. In some non-limiting embodiments or aspects, such systems or devices in FIG. 1 or FIG. 4 may include at least one device 500 and/or at least one component of device 500. The number and arrangement of components shown in FIG. 5 are provided as an example. In some non-limiting embodiments or aspects, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments or aspects, processor 504 may be implemented in hardware, firmware, or a combination of hardware and software. For example, processor 504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 506 may include random access memory (RAM), read only memory (ROM), and/or another type of dynamic or static storage device (e.g., flash memory, magnetic memory, optical memory, etc.) that stores information and/or instructions for use by processor 504.

With continued reference to FIG. 5, storage component 508 may store information and/or software related to the operation and use of device 500. For example, storage component 508 may include a hard disk (e.g., a magnetic disk, an optical disk, a magneto-optic disk, a solid-state disk, etc.) and/or another type of computer-readable medium. Input component 510 may include a component that permits device 500 to receive information, such as via user input (e.g., a touch screen display, a keyboard, a keypad, a mouse, a button, a switch, a microphone, etc.). Additionally or alternatively, input component 510 may include a sensor for sensing information (e.g., a global positioning system (GPS) component, an accelerometer, a gyroscope, an actuator, etc.). Output component 512 may include a component that provides output information from device 500 (e.g., a display, a speaker, one or more light-emitting diodes (LEDs), etc.). Communication interface 514 may include a transceiver-like component (e.g., a transceiver, a separate receiver and transmitter, etc.) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium may include any non-transitory memory device. A memory device includes memory space located inside of a single physical storage device or memory space spread across multiple physical storage devices. Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

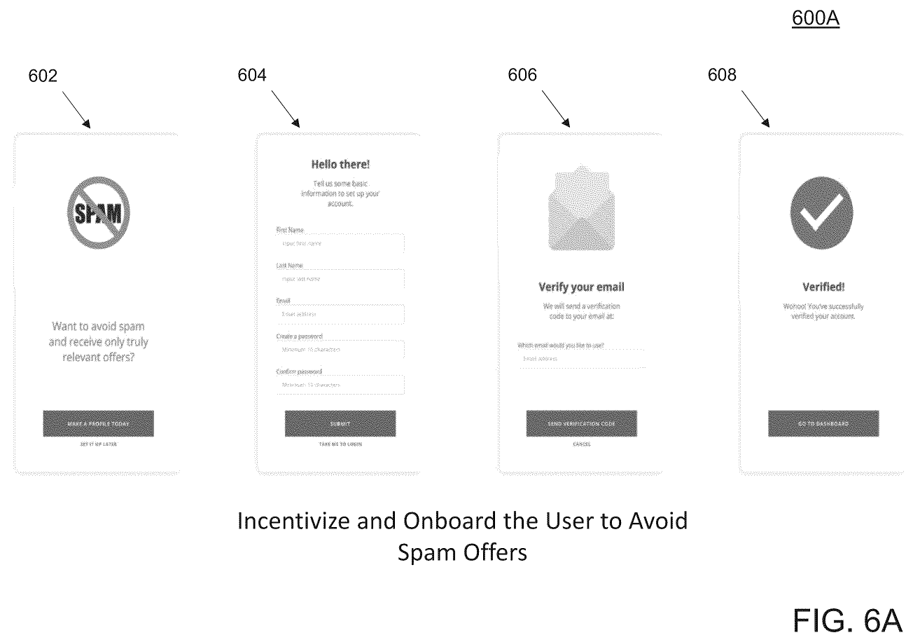

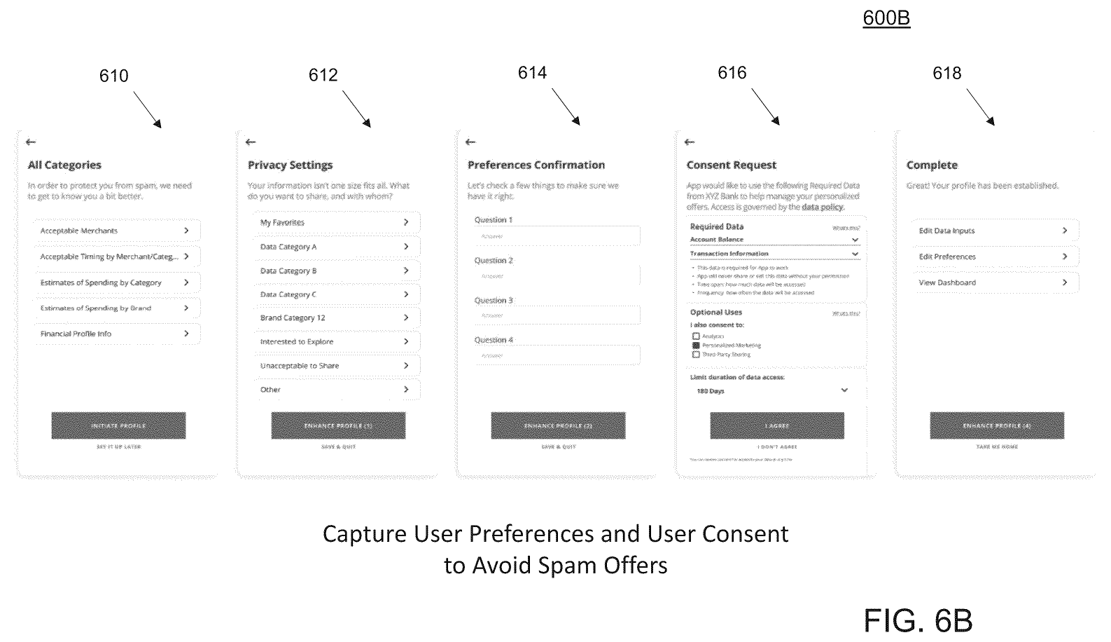

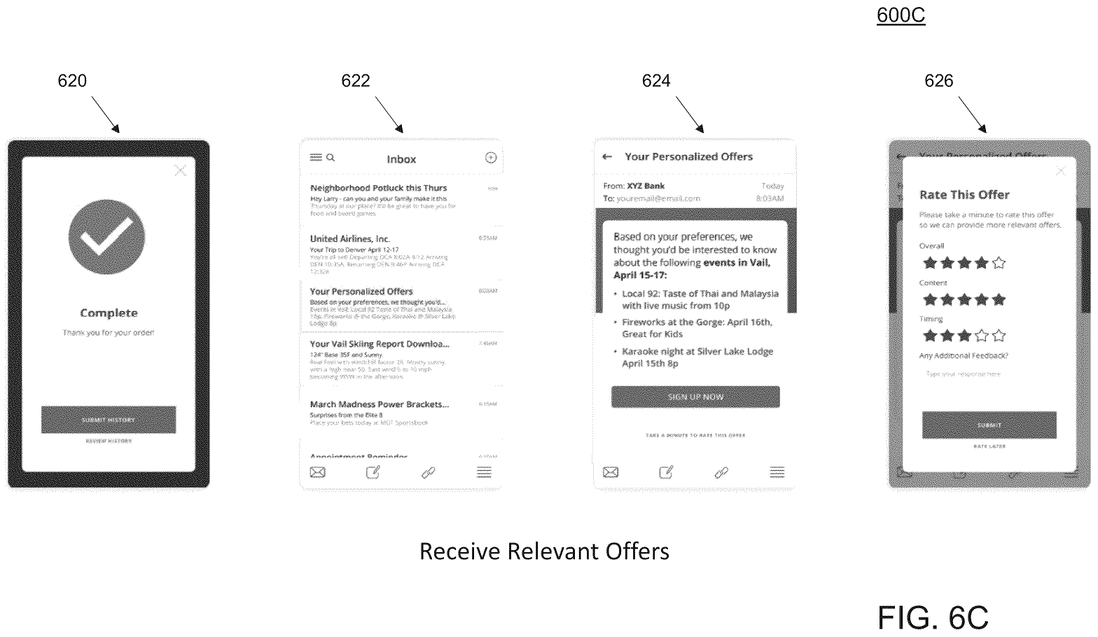

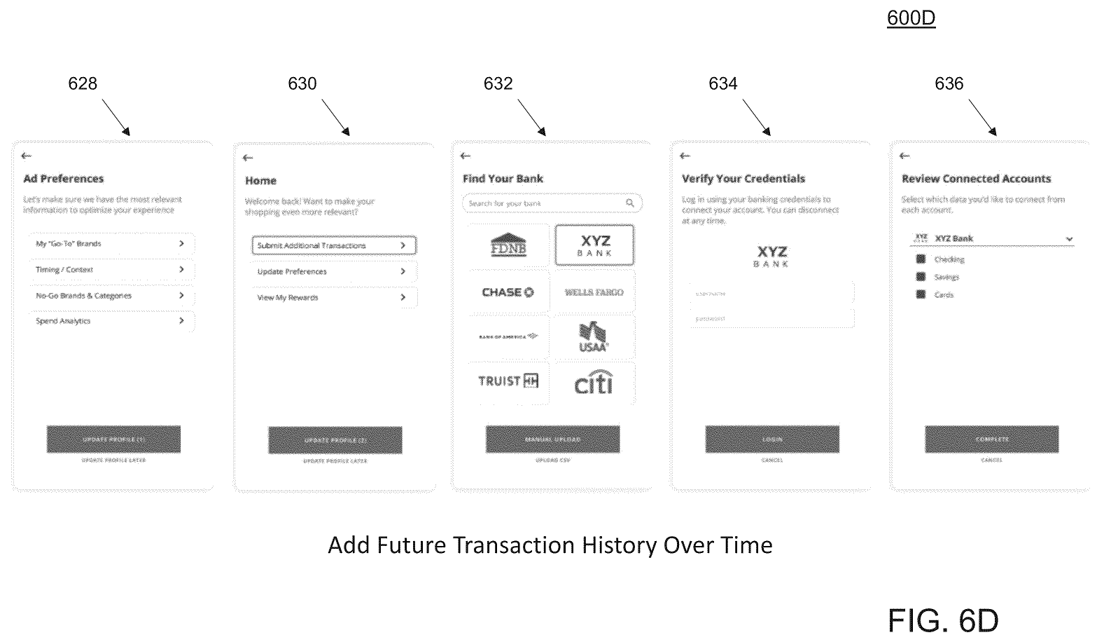

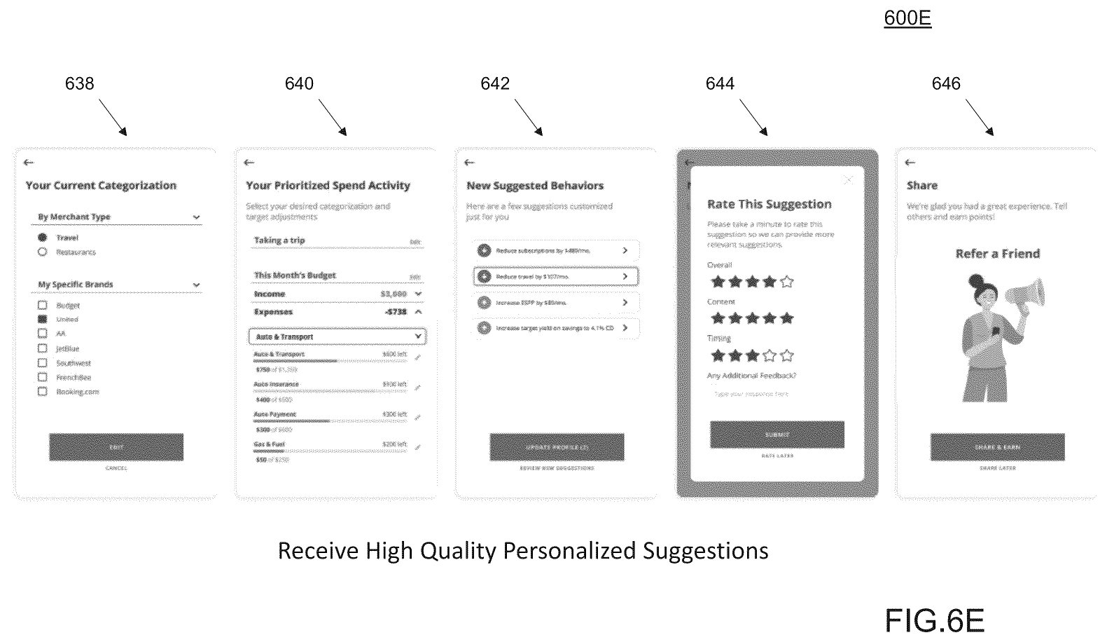

Referring now to FIGS. 6A-6E, FIGS. 6A-6E are exemplary display screens for avoiding spam offers, according to some non-limiting embodiments or aspects. In some non-limiting embodiments or aspects, the display screens shown in FIGS. 6A-6E may be displayed on a user device (e.g., user device 106).

FIG. 6A shows a series of display screens 600A for incentivizing and onboarding the user to avoid spam offers. The series of display screens 600A for incentivizing and onboarding the user to avoid spam offers may include display screens 602, 604, 606, and 608.

In some non-limiting embodiments or aspects, display screens 602, 604, 606, and/or 608 may include one or more interactive graphical user interfaces (GUIs). The one or more interactive GUIs may be configured to display data via a display of a user device and/or receive data input from the user. In some non-limiting embodiments or aspects, the one or more interactive GUIs may be updated based on receiving an input (e.g., input data and/or a selection of a selectable option) from a user. In some non-limiting embodiments or aspects, the one or more interactive GUIs may include a plurality of elements. The plurality of elements may include a drop-down menu configured to be selected by a user and expand, a text box configured to receive text input by the user, a checkbox configured to be selected and/or de-selected by a user, and/or one or more selectable options configured to be selected by a user. A first interactive GUI displayed in a series of interactive GUIs may be updated (e.g., based on a user input) to display a second interactive GUI in the series of interactive GUIs.

In some non-limiting embodiments or aspects, display screen 602 may include an initial promotion to avoid spam and receive only truly relevant offers. In some non-limiting embodiments or aspects, a user may be prompted to input user data, which may then be stored in a database (e.g., database 104) and used to generate relevant offers. The user may manage the data and/or create and/or update user preferences based on the data. In some non-limiting embodiments or aspects, display screen 602 may include selectable options, for example, display screen 602 may include a selectable option to generate a user profile immediately and/or set up a user profile in the future.

In some non-limiting embodiments or aspects, display screen 604 may prompt a user to input data (e.g., first name, last name, email address, create a password, confirm a password) to set up an account. In some non-limiting embodiments or aspects, the data input by the user may be encrypted. In some non-limiting embodiments or aspects, display screen 604 may include selectable options, for example, display screen 604 may include a selectable option to submit the data input by the user and/or to redirect the user to a login page.

In some non-limiting embodiments or aspects, display screen 606 may prompt a user to verify data input by the user, for example, display screen 606 may prompt a user to verify an email address input by the user. In some non-limiting embodiments or aspects, display screen 606 may include selectable options, for example, display screen 606 may include a selectable option to send a verification code to the email address of the user and/or cancel the process.

In some non-limiting embodiments or aspects, display screen 608 may include a verification message. For example, display screen 608 may include a verification message indicating whether the email address input by the user has been verified or not. In some non-limiting embodiments or aspects, display screen 608 may include selectable options, for example, display screen 608 may include a selectable option to redirect the user to a user dashboard.

FIG. 6B shows a series of display screens 600B for capturing preferences and consent from a user. In some non-limiting embodiments or aspects, the series of display screens 600B may be displayed before or after the series of display screens 600A. The series of display screens 600B for capturing preferences and consent from the user may include display screens 610, 612, 614, 616, and 618. Display screens 610, 612, 614, 616, and 618 may include an interactive GUI, as described herein.

In some non-limiting embodiments or aspects, display screen 610 may prompt a user to input data for one or more categories (e.g., acceptable merchants, acceptable timing by merchant/category, estimates of spending by category, estimates of spending by brand, and/or financial profile information). Display screen 610 may include a dropdown menu for each of the one or more categories which, when selected by the user, will prompt the user to make a selection. Display screen 610 may include a selectable option to initiate a profile and/or set up a profile later.

In some non-limiting embodiments or aspects, display screen 612 may prompt a user to input data associated with one or more privacy settings. Display screen 612 may include one or more drop down menus associated with privacy settings for one or more categories (e.g., my favorites, data category A, data category B, data category C, brand category 12, interested to explore, unacceptable to share, and other), configured to be selected by the user. Display screen 612 may include a selectable option to enhance a profile and/or save and quit. In some non-limiting embodiments or aspects, display screen 612 may capture data on an individual ownership and/or a transactional level.

In some non-limiting embodiments or aspects, display screen 614 may prompt a user to input data associated with user preferences. Display screen 614 may include one or more input boxes (e.g., question 1, question 2, question 3, and question 4) configured to receive text (e.g., answer(s)) as an input from the user. Display screen 614 may include a selectable option to enhance a profile and/or save and quit.

In some non-limiting embodiments or aspects, display screen 616 may prompt a user to provide consent to save and/or share data input by the user. Display screen 616 may include a selectable option to enhance a profile and/or save and quit.

In some non-limiting embodiments or aspects, display screen 618 may display a message indicating that the user profile is complete. Display screen 618 may prompt a user to edit data inputs, edit user preferences, and/or view a dashboard. Display screen 618 may include a selectable option to enhance a profile and/or redirect to a home screen (not shown).

FIG. 6C shows a series of display screens 600C for receiving relevant offers. In some non-limiting embodiments or aspects, the series of display screens 600C may be displayed before or after the series of display screens 600B. The series of display screens 600C for receiving relevant offers may include display screens 620, 622, 624, and 626. Display screens 620, 622, 624, and 626 may include an interactive GUI, as described herein.

In some non-limiting embodiments or aspects, display screen 620 may display a message indicating that a transaction is complete. For example, when purchase activity occurs, auto popups may appear to give the user control to preemptively record select details and block irrelevant offers. Display screen 620 may be presented to a user either inside or outside of a user application. Display screen 620 may include a selectable option to submit history and/or review history.

In some non-limiting embodiments or aspects, display screen 622 may include an email inbox. The relevant advertisements may appear in the email inbox based on a user's selection on display screen 620.

In some non-limiting embodiments or aspects, display screen 624 may display a message and/or a personalized offer. For example, an offer (e.g., a relevant offer) may be displayed based on data received from the user. In some non-limiting embodiments or aspects, display screen 624 may prompt the user to sign up for the offer. Display screen 624 may include a selectable option to sign up for the offer.

In some non-limiting embodiments or aspects, display screen 626 may prompt a user to rate an offer. For example, display screen 626 may include one or more selectable options prompting the user to rate the offer overall, the content of the offer, and/or the timing of the offer. Display screen 626 may include an input box configured to receive text (e.g., additional feedback) from the user. Display screen 626 may include a selectable option to submit a rating and/or rate the offer later.

FIG. 6D shows a series of display screens 600D for adding future transaction history over time. In some non-limiting embodiments or aspects, the series of display screens 600D may be displayed before or after the series of display screens 600C. The series of display screens 600D for adding future transaction history over time may include display screens 628, 630, 632, 634, and 636. Display screens 628, 630, 632, 634, and 636 may include an interactive GUI, as described herein.

In some non-limiting embodiments or aspects, display screen 628 may prompt the user to update their user profile based on updating user data (e.g., my “go-to” brands, timing/context, no-go brands, categories, and spend analysis). Display screen 628 may include a selectable option to update the user profile and/or update the user profile later. In some non-limiting embodiments or aspects, an objective of the machine learning model may be to stop new irrelevant advertisements from occurring, using as little user data as possible.

In some non-limiting embodiments or aspects, display screen 630 may provide the user with a home screen, where the user may select to add additional transaction data to a user profile, update preferences of a user profile, and/or to view rewards data associated with a user profile. Display screen 630 may include a selectable option to update the user profile and/or update the user profile later.

In some non-limiting embodiments or aspects, display screen 632 may prompt the user to search and/or select a bank associated with the user and/or a user account. Display screen 632 may include a selectable option to manually upload banking data and/or upload a bank statement formatted as a comma separated value (CSV).

In some non-limiting embodiments or aspects, display screen 634 may prompt a user to verify their user credentials (e.g., username and password). Display screen 634 may prompt a user to log in using their banking credentials to connect to a bank account associated with the user. Display screen 634 may include a selectable option to login and/or cancel.

In some non-limiting embodiments or aspects, display screen 636 may prompt a user to review connected bank accounts. Display screen 636 may include a selectable option to complete the review and/or cancel the review.

FIG. 6E shows a series of display screens 600E for receiving high quality personalized suggestions. In some non-limiting embodiments or aspects, the series of display screens 600E may be displayed before or after the series of display screens 600D. The series of display screens 600E for receiving high quality personalized suggestions may include display screens 638, 640, 642, 644, and 646. Display screens 638, 640, 642, 644, and 646 may include an interactive GUI, as described herein.

In some non-limiting embodiments or aspects, display screen 638 may prompt a user to categorize a merchant type and/or a specific brand. Display screen 638 may include a selectable option to edit the user's categorization and/or cancel.

In some non-limiting embodiments or aspects, display screen 640 may prompt a user to select a desired categorization and/or a target adjustment. In some non-limiting embodiments or aspects, display screen 640 may display a message including a suggestion to make an adjustment per category and/or per brand.

In some non-limiting embodiments or aspects, display screen 642 may display a message including a new suggested behavior (e.g., reduce subscriptions, reduce travel, increase ESPP, increase target yield on savings). Display screen 642 may include a selectable option to update the user profile and/or review the new suggestions.

In some non-limiting embodiments or aspects, display screen 644 may prompt a user to rate a suggestion. Display screen may include a selectable option configured to receive a rating (e.g., suggestion overall, content of the suggestion, timing of the suggestion) and/or an input box configured to receive text (e.g., additional feedback) input by the user. Display screen 644 may include a selectable option to submit a rating for the suggestion and/or rate the suggestion later.

In some non-limiting embodiments or aspects, display screen 646 may prompt a user to refer a friend. Display screen 646 may include a selection option to share and earn and/or share later.

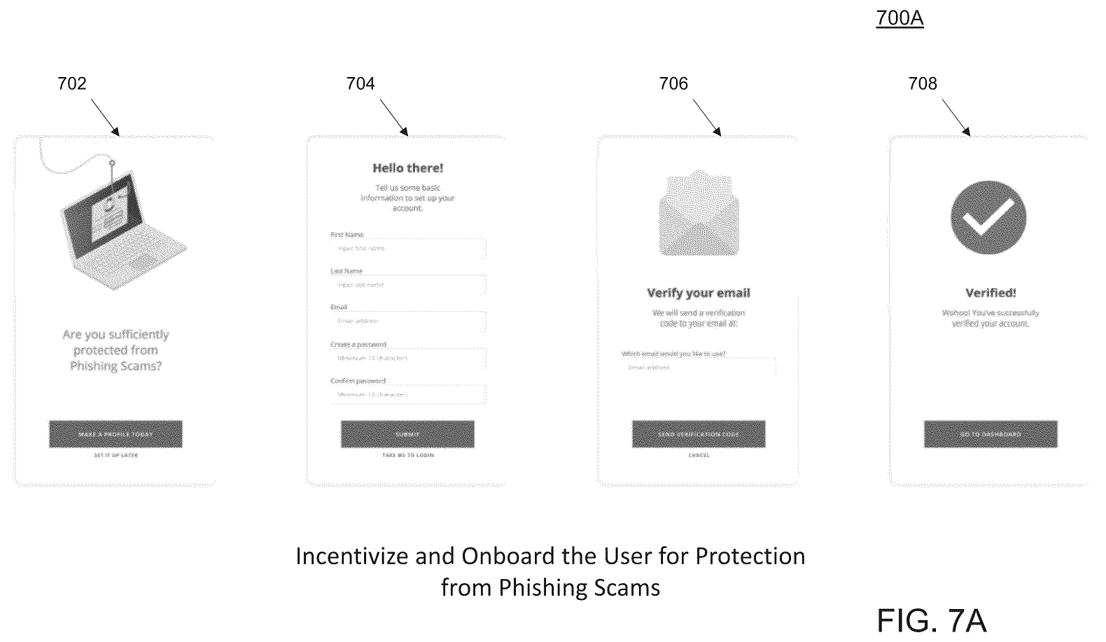

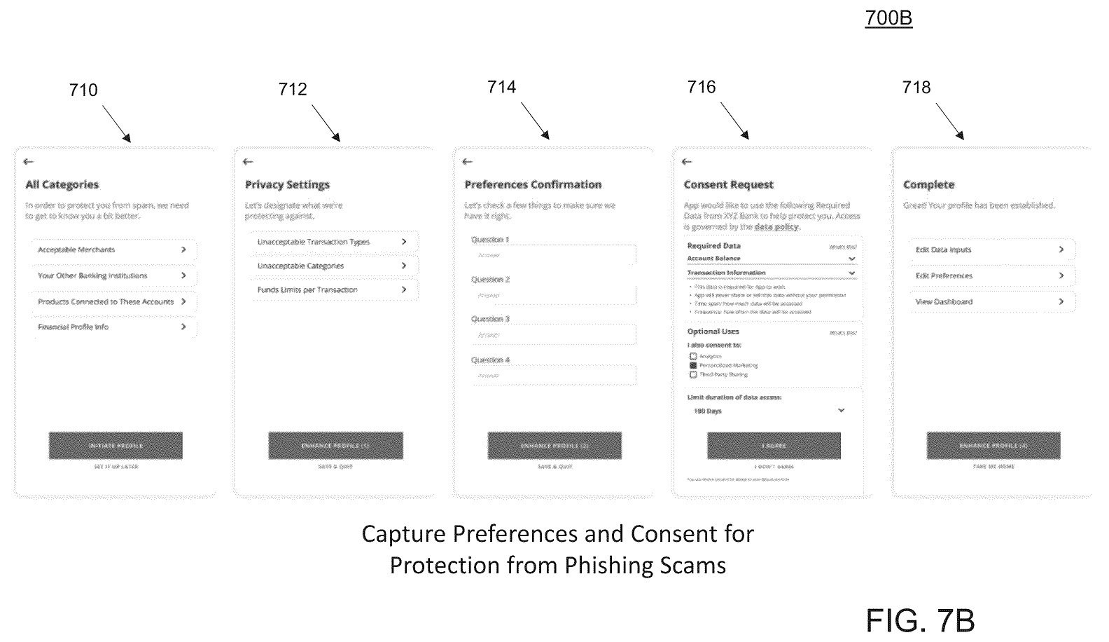

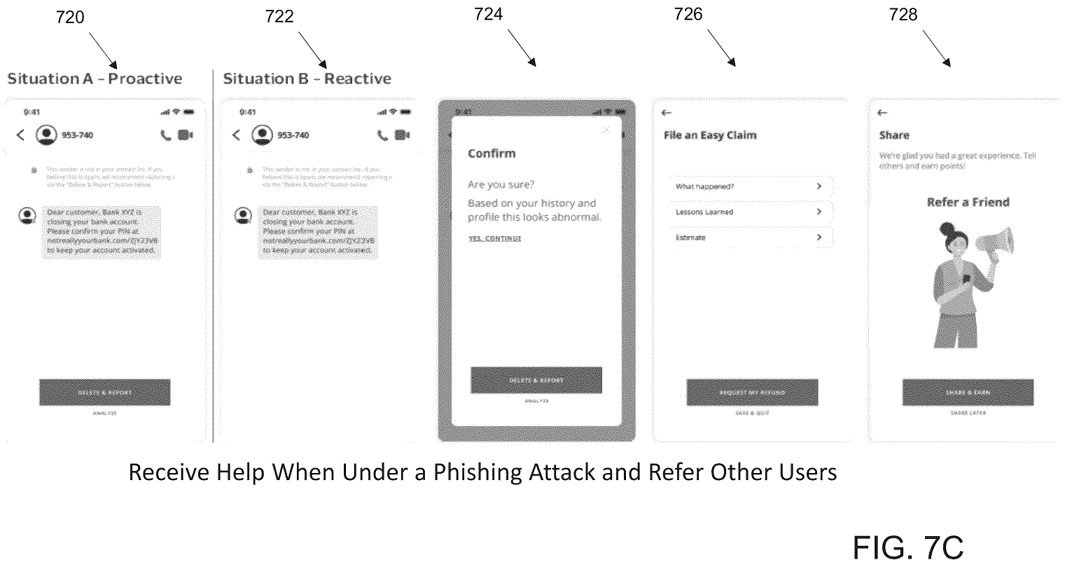

Referring now to FIGS. 7A-7C, FIGS. 7A-7C are exemplary display screens for protection from phishing scams, according to some non-limiting embodiments or aspects. In some non-limiting embodiments or aspects, the display screens shown in FIGS. 7A-7C may be displayed on a user device (e.g., user device 106).

FIG. 7A shows a series of display screens 700A for incentivizing and onboarding the user for protection from phishing scams. The series of display screens 700A for incentivizing and onboarding the user for protection from phishing scams may include display screens 702, 704, 706, and 708. In some non-limiting embodiments or aspects, display screens 702, 704, 706, and 708 may include an interactive GUI, as described herein.

In some non-limiting embodiments or aspects, display screen 702 may display a message (e.g., asking the user if they are sufficiently protected from phishing scams). Display screen 702 may include a selection option to generate a user profile immediately and/or set up a user profile later.

In some non-limiting embodiments or aspects, display screens 704, 706, and/or 708 may be the same as, similar to, and/or part of display screens 604, 606, and 608, respectively.

FIG. 7B shows a series of display screens 700B for capturing preferences and consent for protection from phishing scams. The series of display screens 700B may be displayed before or after the series of display screens 700A. The series of display screens 700B for capturing preferences and consent for protection from phishing scams may include display screens 710, 712, 714, 716, and 718. Display screens 710, 712, 714, 716, and 718 may be the same as, similar to, and or part of display screens 610, 612, 614, 616, and 618, respectively.

FIG. 7C shows a series of display screens 700C for receiving help when under a phishing attack and referring other users. In some non-limiting embodiments or aspects, the series of display screens 700C may be displayed before or after the series of display screens 700B. The series of display screens for receiving help when under a phishing attack and referring other users may include display screens 720, 722, 724, 726, and 728. Display screens 720, 722, 724, 726, and 728 may include an interactive GUI, as described herein.

In some non-limiting embodiments or aspects, display screen 720 may include an automated popup including a message (e.g., a proactive message) associated with a phishing attack. In some non-limiting embodiments or aspects, display screen 720 may include a selectable option to delete and report the phishing attack and/or analyze the phishing attack.

In some non-limiting embodiments or aspects, display screen 722 may include an automated popup including a message (e.g., a reactive message) associated with a phishing attack.

In some non-limiting embodiments or aspects, display screen 724 may include a confirmation message. Display screen 724 may prompt the user to confirm that an activity is an abnormal activity. Display screen 724 may include a selectable option to confirm that the activity is normal and continue, delete, report, and/or analyze.

In some non-limiting embodiments or aspects, display screen 726 may prompt a user to file a claim. Display screen 726 may include drop down menus and/or selectable options for the user to input data (e.g., what happened, lessons learned, estimate). Display screen 726 may include a selectable option to request a refund and/or save and quit. Data input at display screen 726 may be sent to the user's bank and/or input into the machine learning model.

In some non-limiting embodiments or aspects, display screen 728 may prompt a user to refer a friend. Display screen 728 may include a selectable option to share and earn and/or share later.

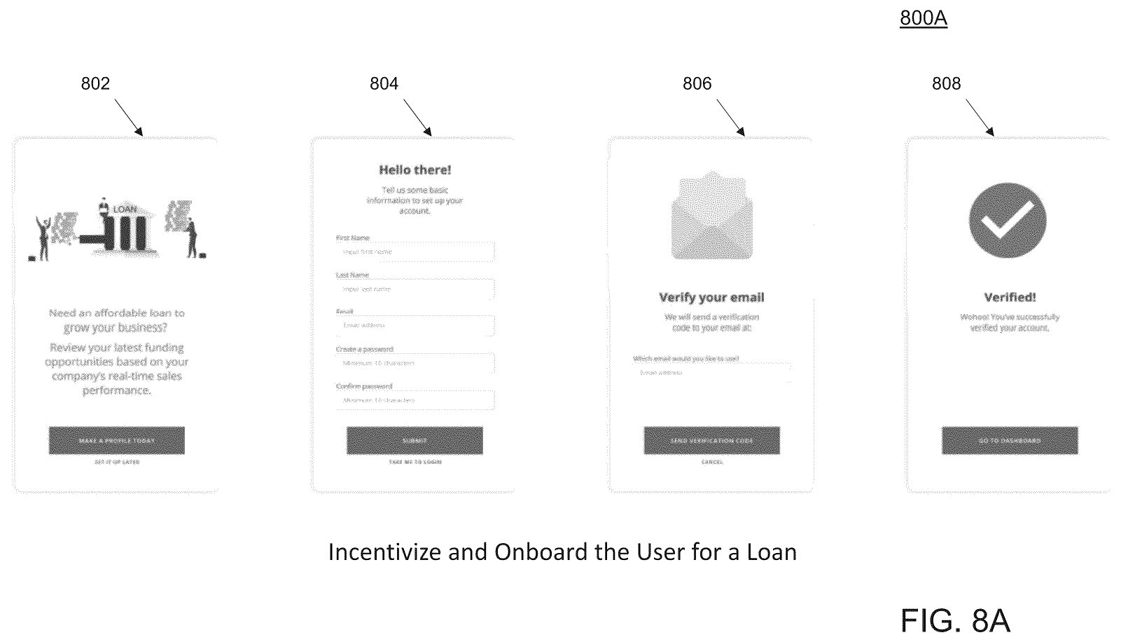

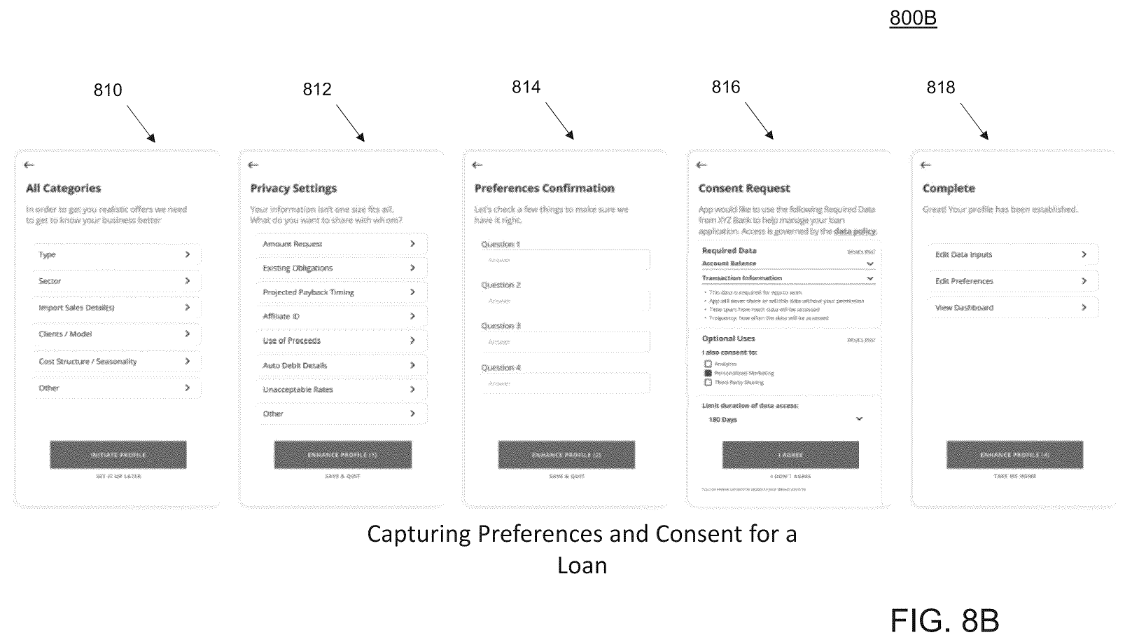

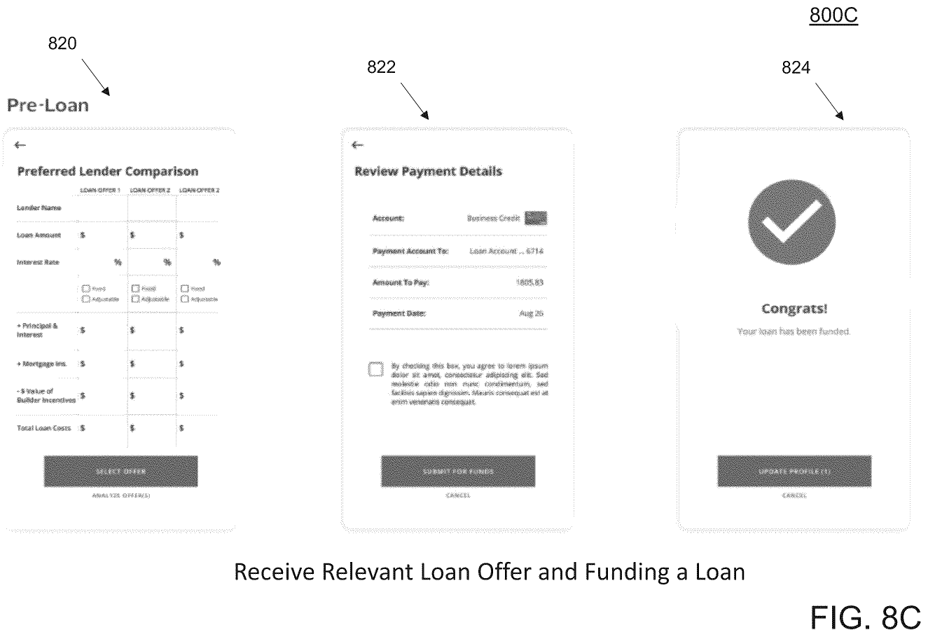

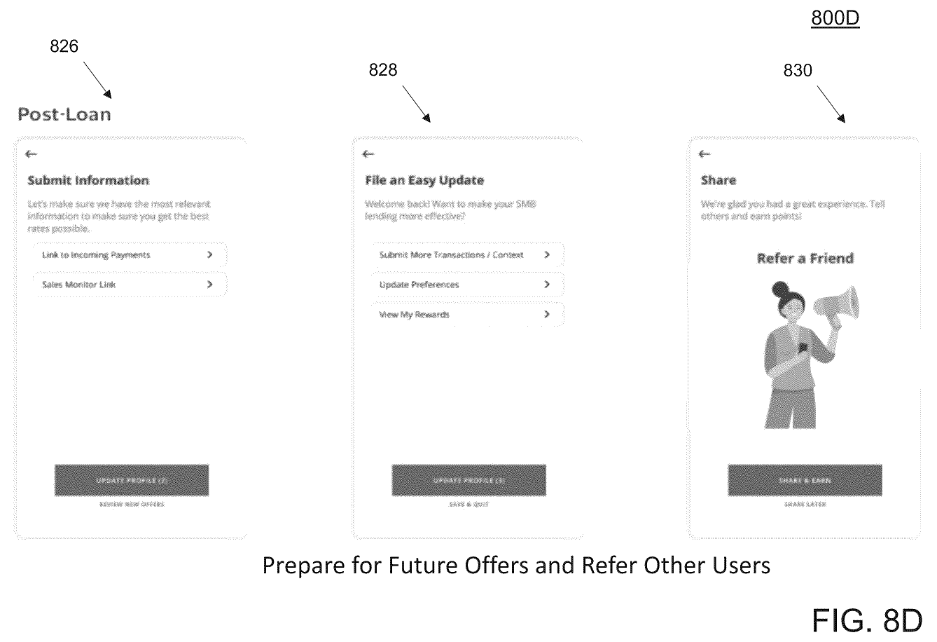

Referring now to FIGS. 8A-8D, FIGS. 8A-8D are exemplary display screens for acquiring a loan, according to some non-limiting embodiments or aspects. In some non-limiting embodiments or aspects, the display screens shown in FIGS. 8A-8D may be displayed on a user device (e.g., user device 106).

FIG. 8A shows a series of display screens 800A for incentivizing and onboarding the user for a loan. The series of display screens for incentivizing and onboarding the user for a loan may include display screens 802, 804, 806, and 808. In some non-limiting embodiments or aspects, display screens 802, 804, 806, and 808 may include an interactive GUI, as described herein.

In some non-limiting embodiments or aspects, display screen 802 may display a message (e.g., asking the user if they need a loan). Display screen 802 may include a selection option to generate a user profile immediately and/or set up a user profile later.

In some non-limiting embodiments or aspects, display screens 804, 806, and 808 may be the same as, similar to, and or part of display screens 704, 706, 708 and/or 604, 606, and 608.

FIG. 8B shows a series of display screens 800B for capturing preferences and consent for a loan. In some non-limiting embodiments or aspects, the series of display screens 800B may be displayed before or after the series of display screens 800A. The series of display screens 800B for capturing preferences and consent for a loan may include display screens 810, 812, 814, 816, and 818. Display screens 810. 812, 814, 816, and 818 may include an interactive GUI, as described herein. Display screens 810, 812, 814, 816, and 818 may be the same as, similar to, and/or part of display screens 610, 612, 614, 616, and/or 618, respectively.

FIG. 8C shows a series of display screens 800C for receiving relevant offers (e.g., loan offers) and for funding a loan. In some non-limiting embodiments or aspects, the series of display screens 800C may be displayed before or after the series of display screens 800B. The series of display screens 800C may include display screens 820, 822, and 824. Display screens 820, 822, and 824 may include an interactive GUI, as described herein.

In some non-limiting embodiments or aspects, display screen 820 may display a preferred lender comparison table including lender data (e.g., lender name, loan amount, interest rate, principal and interest, mortgage insurance, value of builder incentives, total loan costs, and/or one or more loan offers). Display screen 820 may include a selection option to select an offer and/or analyze an offer.

In some non-limiting embodiments or aspects, display screen 822 may prompt a user to review payment details and confirm by selecting a checkbox. Display screen 822 may include a selection option to submit for funds and/or cancel.

In some non-limiting embodiments or aspects, display screen 824 may display a confirmation message. For example, display screen 824 may display a confirmation message once the loan has been funded. Display screen 824 may include a selectable option to update the user profile and/or cancel.

FIG. 8D shows a series of display screens 800D for preparing for future offers and referring other users. In some non-limiting embodiments or aspects, the series of display screens 800D may be displayed before or after the series of display screens 800C. The series of display screens 800D for preparing for future offers and referring other users may include display screens 826, 828, and 830. Display screens 826, 828, and 830 may include an interactive GUI, as described herein.

In some non-limiting embodiments or aspects, display screen 826 may prompt a user to submit information (e.g., link to incoming payments and sales monitor link). Display screen 826 may include a selectable option to update the user profile and/or review new offers. In some non-limiting embodiments or aspects, information received at display screen 826 may be sent to a lending institution. The lending institution may generate and send a subsequent offer to the user based on the information received by the lending institution.

In some non-limiting embodiments or aspects, display screen 828 may prompt a user to file an update. For example, display screen 828 may prompt a user to input data (e.g., submit more transactions/context, update preferences) and/or view of rewards. Display screen 828 may include a selectable option to update the user profile and/or save and quit.

In some non-limiting embodiments or aspects, display screen 830 may prompt the user to refer another user (e.g., refer a friend). Display screen 830 may include a selectable option to share and earn and/or share later.

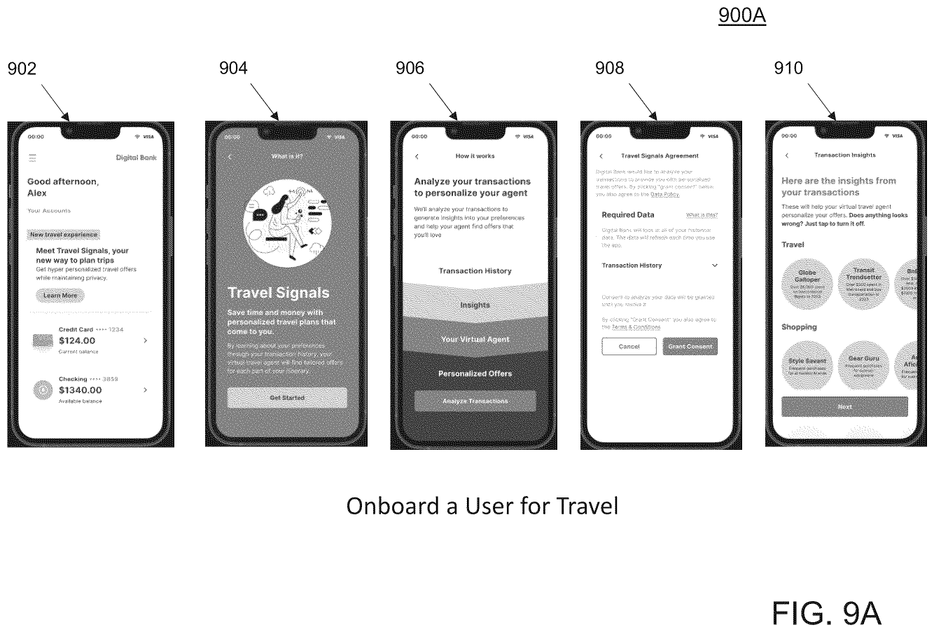

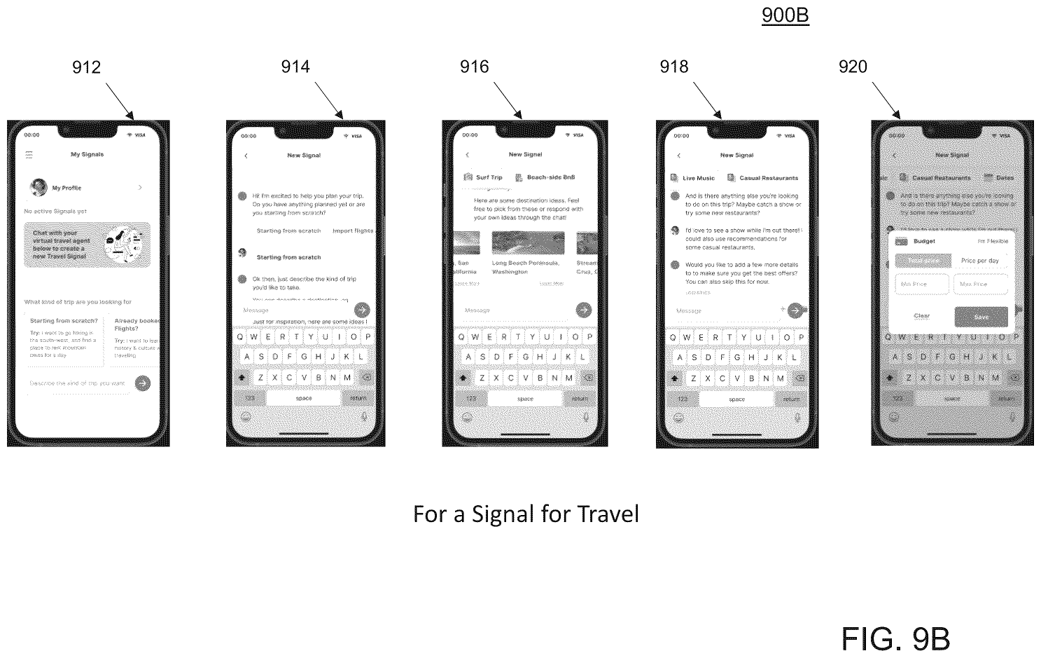

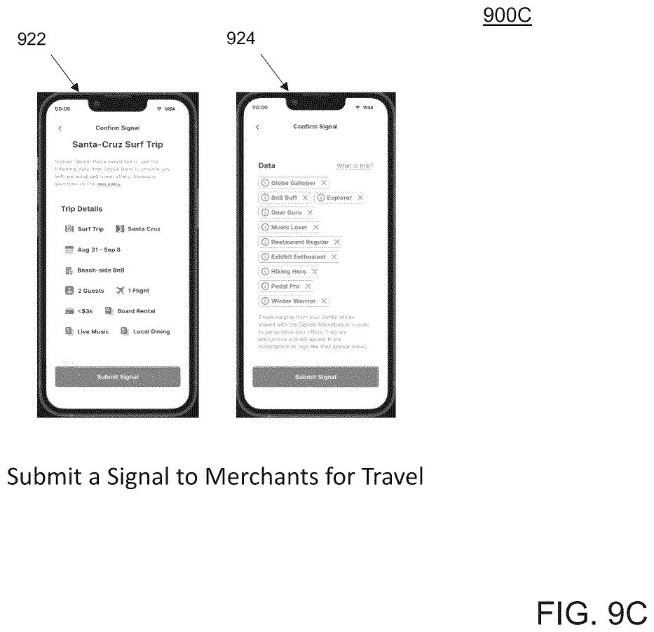

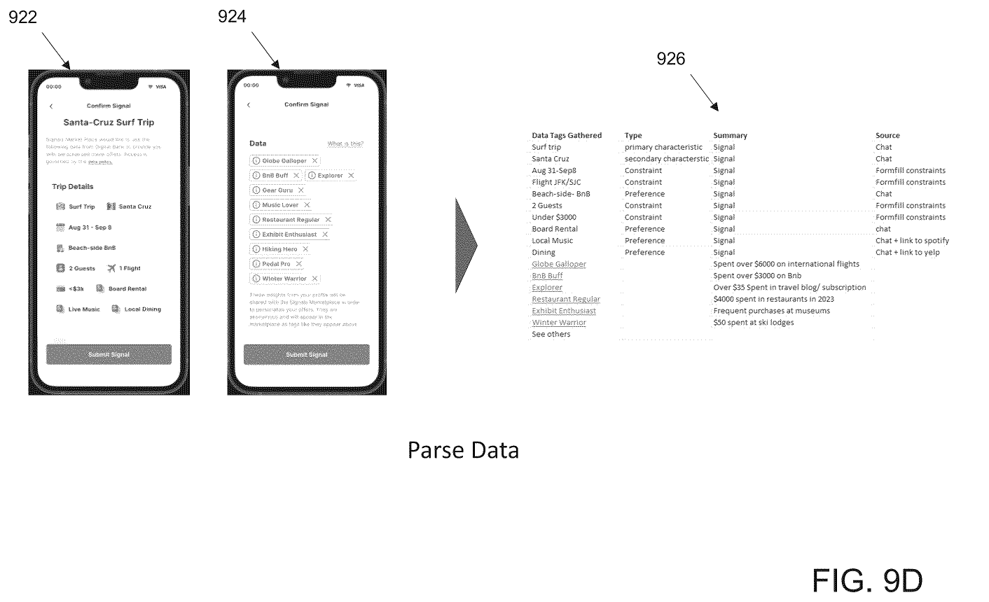

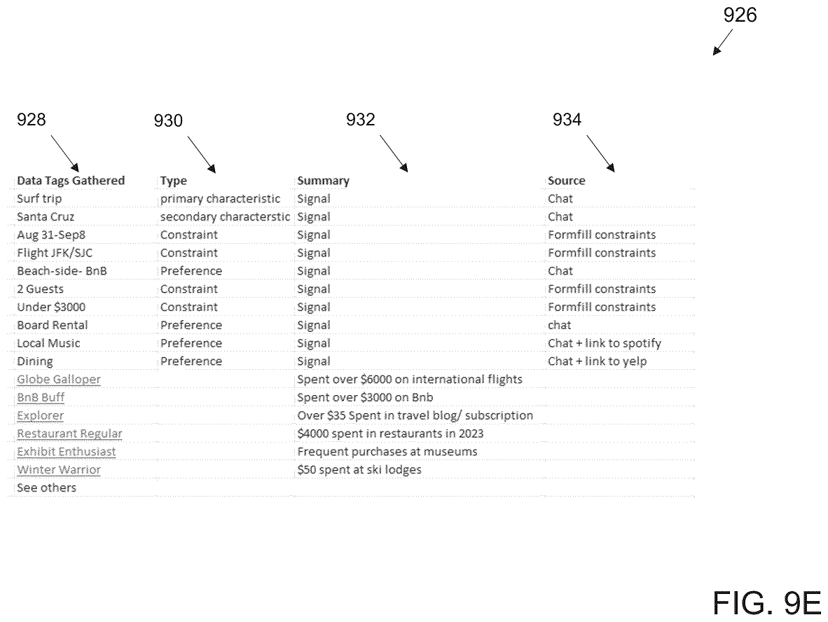

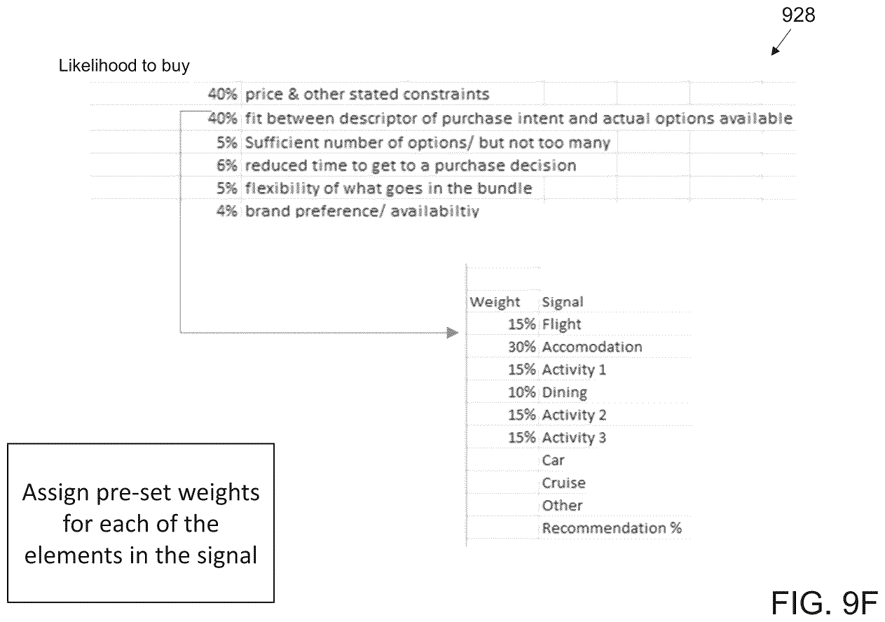

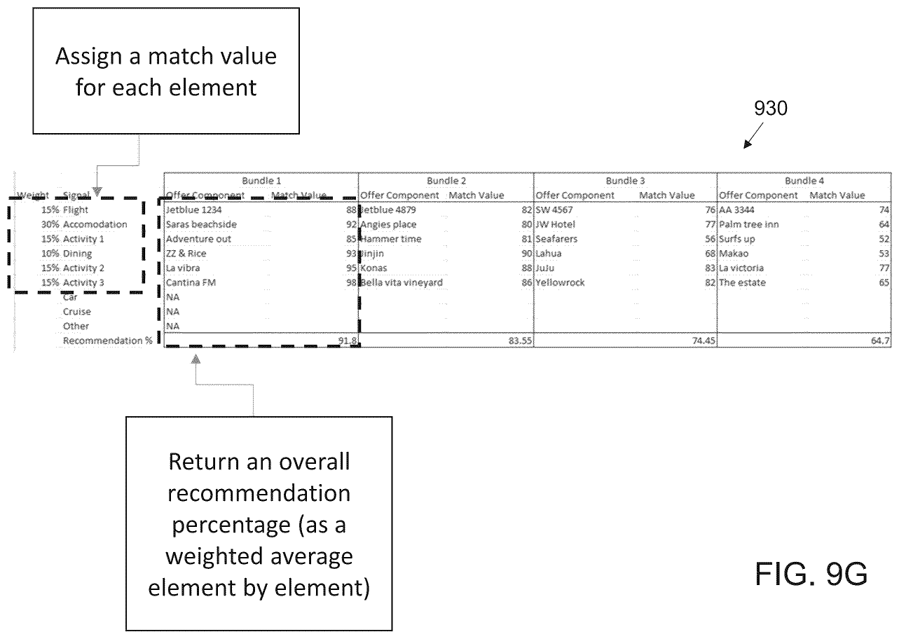

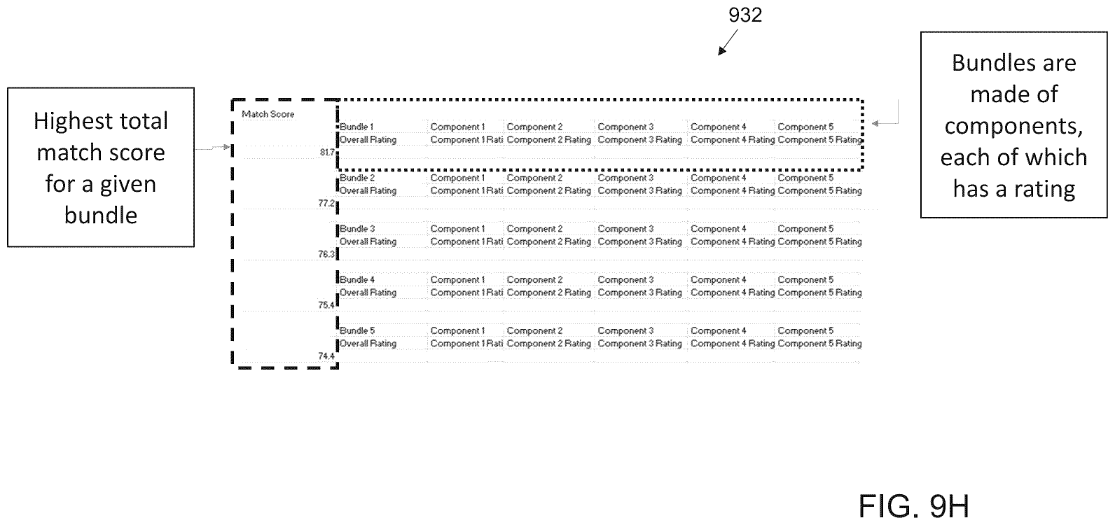

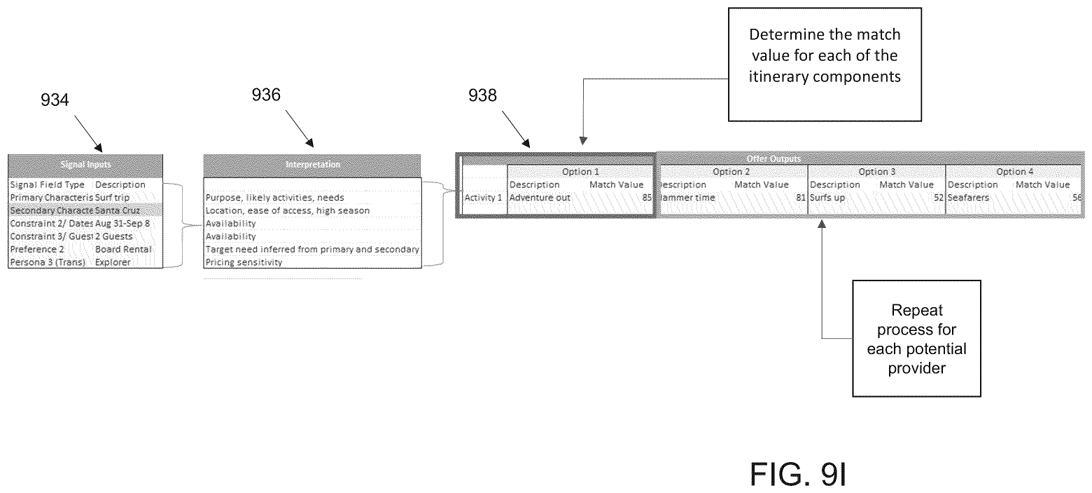

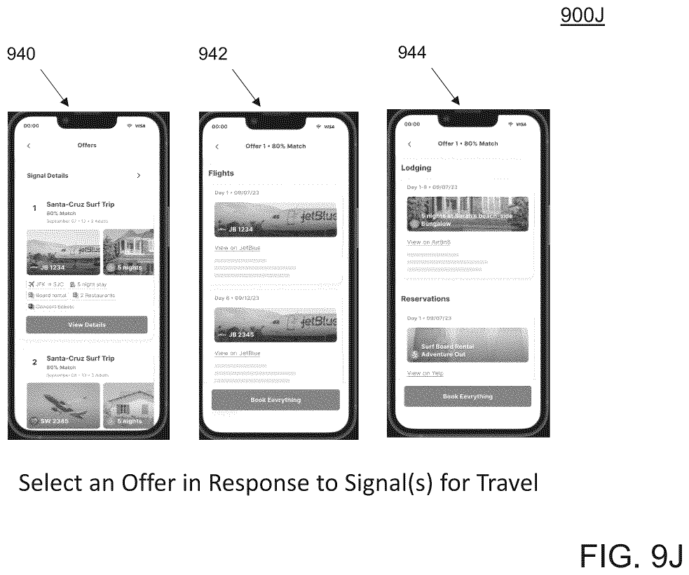

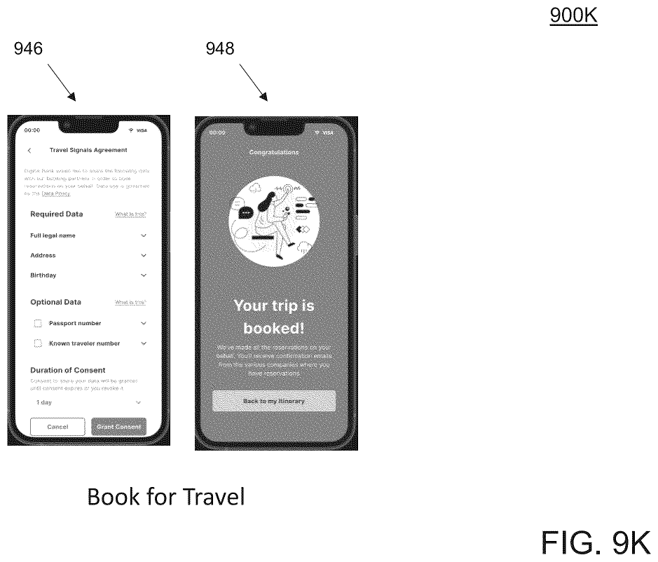

Referring now to FIGS. 9A-9K, FIGS. 9A-9K are exemplary display screens for booking travel, according to some non-limiting embodiments or aspects. In some non-limiting embodiments or aspects, the display screens shown in FIGS. 9A-9K may be displayed on a user device (e.g., user device 106).

FIG. 9A shows a series of display screens 900A for onboarding a user for travel. The series of display screens 900A for onboarding a user for travel may include display screens 902, 904, 906, 908, and 910. In some non-limiting embodiments or aspects, display screens 902, 904, 906, 908, and 910 may include an interactive GUI, as described herein.

In some non-limiting embodiments or aspects, display screen 902 may prompt a user to select an option to learn more about personalizing travel offers. Display screen 902 may display a message including an offer to use travel signals to plan a trip. Display screen 902 may display an account balance (e.g., a credit card balance or a checking account balance). In some non-limiting embodiments or aspects, display screen 902 may be displayed within an application (e.g., within the user's banking application).

Display screen 904 may include a selectable option to get started. Display screen 906 may prompt the user to analyze their transactions to generate personalized offers. Display screen 906 may prompt the user to share transaction history data to build the user profile. Display screen 906 may include a selection option to analyze user transactions. Display screen 908 may display data associated with an agreement and/or use policy. Display screen 908 may include a selectable option to grant user consent to share transaction data for a limited time and/or cancel. Display screen 910 may provide data associated with the user's transactions (e.g., insights). Display screen 910 may display transaction data that had been converted into “insights.” The insights may be divided into categories (e.g., travel and shopping). The insights may include “Globe Galloper” for a user who satisfies a threshold value of money spent on flights over a period of time, “Transit Trendsetter” for a user who satisfies a threshold value of money spent on bus transportation, “Style Savant” for a user who frequently makes purchases from fashion brands, and “Gear Guru” for a user who frequently purchases outdoor equipment. Display screen 910 may prompt the user to share an insight to enhance their travel search. In some non-limiting embodiments or aspects, a user may return to display screen 910 at any time to update data associated with the user's insights.

FIG. 9B shows a series of display screens 900B for forming a signal for travel. In some non-limiting embodiments or aspects, the series of display screens 900B may be displayed before or after the series of display screens 900A. The series of display screens 900B for forming a signal may include display screens 912, 914, 916, 918, and 920 for performing process 900B for signal formation for travel after performing process 900A for onboarding the user for travel. Display screens 912, 914, 916, 918, and 920 may include an interactive GUI, as described herein.

In some non-limiting embodiments or aspects, display screen 912 may include a message based on an insight selected by the user. Display screen 912 may include a text box configured to receive an input from the user. For example, the text box may prompt the user to input data regarding a trip.

In some non-limiting embodiments or aspects, display screen 914 may display a chat with the user. Display screen 914 may prompt the user to input further data regarding the trip via a text box configured to receive text input by the user. The data input by the user may be stored in a database (e.g., database 104) as a draft signal.

In some non-limiting embodiments or aspects, display screen 916 may provide a message including a suggestion based on the selected insight and/or data input by the user stored in the database. For example, display screen 916 may provide a message including a suggestion for a travel destination based on the selected insight and/or data input by the user stored in the database.

In some non-limiting embodiments or aspects, display screen 918 may prompt the user to input further data regarding the trip via a text box configured to receive text input by the user.

In some non-limiting embodiments or aspects, display screen 920 may be prompted to enter further data regarding the trip (e.g., budget constraints, number of guests, starting location, etc.). Display screen 920 may prompt the user to input a budget including a total price and/or a price per day (e.g., a minimum price and/or a maximum price). Display screen 920 may include a text box configured to receive the budget data and/or a selectable option to clear the budget data and/or save the budget data.

FIG. 9C shows a series of display screens 900C for submitting a signal to merchants for travel. In some non-limiting embodiments or aspects, the series of display screens 900C may be displayed before or after the series of display screens 900B. The series of display screens 900C for submitting a signal to merchant for travel may include display screens 922 and 924. Display screens 922 and 924 may include an interactive GUI, as described herein.

In some non-limiting embodiments or aspects, display screen 922 may include one or more selectable options associated with a plurality of elements (e.g., trip details, such as type of trip (surf trip), location, dates, lodging, number of guests, flights, budget, rentals (board rentals), entertainment (live music), and dining). In some non-limiting embodiments or aspects, the trip details may be generated based on data input by the user in 900A and 900B. In some non-limiting embodiments or aspects, the signal may include the trip details and/or the signal may be generated based on the trip details. Display screen 922 may include a selectable option to submit the signal to a plurality of merchants (e.g., a network of merchants) to indicate the user's preferences (e.g., where the user wants to travel to and how much they are willing to pay).

In some non-limiting embodiments or aspects, the insights selected by the user may be included in the signal. In some non-limiting embodiments or aspects, display screen 924 may include one or more selectable options to de-select an insight included in the signal.

FIG. 9D shows table 926 which includes data parsed from the signal. For example, the data displayed by display screens 922 and 924 may be parsed (e.g., by machine learning system 102) into table 926. In some non-limiting embodiments or aspects, machine learning system 102 may parse data from the signal into table 926.

As shown in FIG. 9E, table 926 may include a plurality of columns including data tags gathered 928, type 930, summary 932, and/or source 934.

As shown in FIG. 9F, after parsing the signal, machine learning system 102 may assign a pre-set weight for each of the elements in the signal, as shown in table 928.

As shown in FIG. 9G, after assigning the pre-set weight for each of the elements of the signal, machine learning system 102 may assign a match value for each element. In some non-limiting embodiments or aspects, machine learning system 102 may return an overall recommendation percentage (e.g., as a weighted average element by element), as shown in table 930. In some non-limiting embodiments or aspects, table 930 may include a likelihood to be (e.g., a percentage) associated with an element and/or a weight associated with a signal. Table 930 may include a weight associated with a signal and one or more bundles (e.g., bundle 1, bundle 2, bundle 3, bundle 4). In some non-limiting embodiments or aspects, machine learning system 102 may assign a match value for each element. In some non-limiting embodiments or aspects, machine learning system 102 may return an overall recommendation percentage (e.g., as a weighted average element by element).

As shown in FIG. 9H, table 932 may include a match score, the one or more bundles (e.g., bundle 1, bundle 2, bundle 3, bundle 4), and/or one or more components. The match score may include a highest total match score for a given bundle. In some non-limiting embodiments or aspects, each bundle may include one or more components, where each component includes a rating. In some non-limiting embodiments or aspects, machine learning system 102 may train a model based on the data from table 932 to provide more accurately ranked options.

As shown in FIG. 9I, table 934 includes a plurality of signal inputs, table 936 includes a plurality of signal interpretations based on the plurality of signal inputs, and table 938 includes a plurality of offer outputs based on the plurality of signal inputs and/or the plurality of signal interpretations. In some non-limiting embodiments or aspects, machine learning system 102 may generate the plurality of offer outputs based on receiving the plurality of signal inputs and/or the plurality of signal interpretations. Machine learning system 102 may determine the match value for each of the itinerary components. Machine learning system 102 may repeat the process for each potential provider.

FIG. 9J shows a series of display screens 900J for selecting an offer in response to signals for travel. The series of display screens 900J may be displayed in response to submitting the signal to the plurality of merchants.

In response to receiving the signal, a merchant of the plurality of merchants may generate and/or display an offer based on the signal.

The series of display screens 900J for selecting an offer in response to signals for travel may include display screens 940, 942, and 944. Display screens 940, 942, and 944 may include an interactive GUI, as described herein.

In some non-limiting embodiments or aspects, display screen 940 may display data associated with a trip based on the signal. The data associated with the trip may include an offer for a trip curated based on the signal. Display screen 940 may prompt the user to view the trip details. Display screen 940 may include a selectable option to view the trip details.

In some non-limiting embodiments or aspects, display screen 942 may display data associated with flight information based on the signal. The data associated with the flight information may include an offer for a flight curated based on the signal. Display screen 942 may prompt a user to view flight information and/or book a flight (e.g., accept an offer). Display screen 942 may include a selectable option to book a flight.

In some non-limiting embodiments or aspects, display screen 944 may display data associated with lodging and/or dining based on the signal. The data associated with the lodging and/or dining may include an offer for lodging and/or an offer to book a reservation at a restaurant curated based on the signal. Display screen 944 may prompt a user to view lodging and/or dining options. Display screen 944 may include a selectable option to view lodging details, view dining details, and/or book lodging and/or dining.

FIG. 9K shows a series of display screens 900K for booking travel. The series of display screens 900K for booking travel may be displayed before or after the series of display screens 900J. The series of display screens 900K for booking travel may include display screens 946 and 948. Display screens 946 and 948 may include an interactive GUI, as described herein.

In some non-limiting embodiments or aspects, display screen 946 may prompt a user to input required data (e.g., full legal name, address, birthday) and/or optional data (e.g., passport number and/or known traveler number). Display screen 946 may prompt a user to select a period of a duration of consent for storing/sharing the user data (e.g., 1 day). Display screen 946 may prompt a user to grant user consent to store/share the user data. Display screen 946 may include a selectable option to grant consent and/or cancel.

In some non-limiting embodiments or aspects, display screen 948 may include a message including an indication that a trip has been booked. Display screen 948 may include a selectable option to go back to a user itinerary.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, user profile data comprising privacy settings data and interest preference data of a user;
storing, with at least one processor, the user profile data in a database;
inputting, with at least one processor, the interest preference data into a machine learning algorithm to generate at least one match between the user and at least one merchant of a plurality of merchants, wherein the at least one merchant comprises a subset of the plurality of merchants;
based on the at least one match, generating, with at least one processor, at least one data sharing message by:
compiling first data associated with the user, the first data comprising the interest preference data and data associated with the at least one merchant;
filtering the first data based on at least one of the interest preference data and the privacy settings data to generate shareable data comprising a subset of at least one of the interest preference data and the data associated with the at least one merchant; and
for each merchant associated with the subset of the data associated with the at least one merchant, generating a corresponding data sharing message containing the subset of interest preference data; and
distributing, with at least one processor, the corresponding data sharing message to each merchant system associated with each merchant associated with the subset of the data associated with the at least one merchant.

2. The computer-implemented method of claim 1, further comprising preventing distribution of the interest preference data to merchants of the plurality of merchants not associated with the subset of the data associated with the at least one merchant.

3. The computer-implemented method of claim 1, further comprising:
causing, with at least one processor, a white label configured user interface to display on a device of the user through a merchant system during a transaction between the user and the merchant system; and
receiving, with the at least one processor, the user profile data in response to the user engaging the white label configured user interface.

4. The computer-implemented method of claim 1, further comprising:
receiving, with at least one processor, merchant profile data for each merchant of the plurality of merchants, the merchant profile data comprising merchant preference data;
inputting, with at least one processor, the merchant profile data into the machine learning algorithm; and
generating, with at least one processor, the at least one match between the user and at least one merchant using the machine learning algorithm based on the interest preference data and the merchant preference data.

5. The computer-implemented method of claim 1, further comprising:
in response to a device of the user receiving a first offer from a merchant to which a data sharing message was distributed, causing, with at least one processor, a feedback user interface to display on the device of the user, the feedback user interface comprising at least one selectable element;
receiving, with at least one processor, feedback data from the user device based on a user input to the feedback user interface by the user interacting with the at least one selectable element; and
inputting, with at least one processor, the feedback data to the machine learning algorithm to further train the machine learning algorithm.

6. The computer-implemented method of claim 1, further comprising:
compiling, with at least one processor, a plurality of offers for the user from a plurality of merchants to which a data sharing message was distributed;
generating, with at least one processor, an offers message comprising the compiled plurality of offers; and
transmitting, with at least one processor, the offers message to a device of the user.

7. The computer-implemented method of claim 1, further comprising:
receiving, with at least one processor, user profile data from a source that has proactively been added as an accessible source;
receiving, with at least one processor and from a device of the user, updated user profile data comprising updated interest preference data, updated privacy settings data, and/or updated historical user transaction data; and
storing and/or replacing, with at least one processor and in the database, the interest preference data and privacy settings data with the updated interest preference data, the updated privacy settings data, and/or the updated historical user transaction data.

8. A system, comprising:
at least one processor configured to:
receive user profile data comprising privacy settings data and interest preference data of a user;
store the user profile data in a database;
input the interest preference data into a machine learning algorithm to generate at least one match between the user and at least one merchant of a plurality of merchants, wherein the at least one merchant comprises a subset of the plurality of merchants;
based on the at least one match, generate at least one data sharing message, wherein when generating the at least one data sharing message, the at least one processor is configured to:
compile first data associated with the user, the first data comprising the interest preference data and data associated with the at least one merchant;
filter the first data based on at least one of the interest preference data and the privacy settings data to generate shareable data comprising a subset of at least one of the interest preference data and the data associated with the at least one merchant; and
for each merchant associated with the subset of the data associated with the at least one merchant, generate a corresponding data sharing message containing the subset of interest preference data; and
distribute the corresponding data sharing message to each merchant system associated with each merchant associated with the subset of the data associated with the at least one merchant.

9. The system of claim 8, wherein the at least one processor is further configured to:
prevent distribution of the interest preference data to merchants of the plurality of merchants not associated with the subset of the data associated with the at least one merchant.

10. The system of claim 8, wherein the at least one processor is further configured to:
cause a white label configured user interface to display on a device of the user through a merchant system during a transaction between the user and the merchant system; and
receive the user profile data in response to the user engaging the white label configured user interface.

11. The system of claim 8, wherein the at least one processor is further configured to:
receive merchant profile data for each merchant of the plurality of merchants, the merchant profile data comprising merchant preference data;
input the merchant profile data into the machine learning algorithm; and
generate the at least one match between the user and at least one merchant using the machine learning algorithm based on the interest preference data and the merchant preference data.

12. The system of claim 8, wherein the at least one processor is further configured to:
in response to a device of the user receiving a first offer from a merchant to which a data sharing message was distributed, cause a feedback user interface to display on the device of the user, the feedback user interface comprising at least one selectable element;
receive feedback data from the user device based on a user input to the feedback user interface by the user interacting with the at least one selectable element; and
input the feedback data to the machine learning algorithm to further train the machine learning algorithm.

13. The system of claim 8, wherein the at least one processor is further configured to:
compile a plurality of offers for the user from a plurality of merchants to which a data sharing message was distributed;
generate an offers message comprising the compiled plurality of offers; and
transmit the offers message to a device of the user.

14. The system of claim 8, wherein the at least one processor is further configured to:
receive user profile data from a source that has proactively been added as an accessible source;
receive, from a device of the user, updated user profile data comprising updated interest preference data, updated privacy settings data, and/or updated historical user transaction data; and
store and/or replace, in the database, the interest preference data and privacy settings data with the updated interest preference data, the updated privacy settings data, and/or the updated historical user transaction data.

15. A computer program product comprising at least one non-transitory computer-readable medium including program instructions that, when executed by at least one processor, cause the at least one processor to:
receive user profile data comprising privacy settings data and interest preference data of a user;
store the user profile data in a database;
input the interest preference data into a machine learning algorithm to generate at least one match between the user and at least one merchant of a plurality of merchants, wherein the at least one merchant comprises a subset of the plurality of merchants;
based on the at least one match, generate at least one data sharing message, wherein when generating the at least one data sharing message, the instructions cause the at least one processor to:
compile first data associated with the user, the first data comprising the interest preference data and data associated with the at least one merchant;
filter the first data based on at least one of the interest preference data and the privacy settings data to generate shareable data comprising a subset of at least one of the interest preference data and the data associated with the at least one merchant; and
for each merchant associated with the subset of the data associated with the at least one merchant, generate a corresponding data sharing message containing the subset of interest preference data; and
distribute the corresponding data sharing message to each merchant system associated with each merchant associated with the subset of the data associated with the at least one merchant.

16. The computer program product of claim 15, wherein the instructions further cause the at least one processor to:
prevent distribution of the interest preference data to merchants of the plurality of merchants not associated with the subset of the data associated with the at least one merchant.

17. The computer program product of claim 15, wherein the instructions further cause the at least one processor to:
cause a white label configured user interface to display on a device of the user through a merchant system during a transaction between the user and the merchant system; and
receive the user profile data in response to the user engaging the white label configured user interface.

18. The computer program product of claim 15, wherein the instructions further cause the at least one processor to:
receive merchant profile data for each merchant of the plurality of merchants, the merchant profile data comprising merchant preference data;
input the merchant profile data into the machine learning algorithm; and
generate the at least one match between the user and at least one merchant using the machine learning algorithm based on the interest preference data and the merchant preference data.

19. The computer program product of claim 15, wherein the instructions further cause the at least one processor to:
in response to a device of the user receiving a first offer from a merchant to which a data sharing message was distributed, cause a feedback user interface to display on the device of the user, the feedback user interface comprising at least one selectable element;
receive feedback data from the user device based on a user input to the feedback user interface by the user interacting with the at least one selectable element; and
input the feedback data to the machine learning algorithm to further train the machine learning algorithm.

20. The computer program product of claim 15, wherein the instructions further cause the at least one processor to:
compile a plurality of offers for the user from a plurality of merchants to which a data sharing message was distributed;
generate an offers message comprising the compiled plurality of offers; and
transmit the offers message to a device of the user.
